(19) United States
(12) Patent Application Publication
(10) Pub. No.: US 2026/0056392 A1
(43) Pub. Date: Feb. 26, 2026

(54) FOLDED OPTICS FOR VIDEO PASS-THROUGH IMAGING

(71) Applicant: QUALCOMM Incorporated, San Diego, CA (US)

(72) Inventor: Micha GALOR GLUSKIN, San Diego, CA (US)

(21) Appl. No.: 18/810,325

(22) Filed: Aug. 20, 2024

(51) Int. Cl. G02B 13/00; G02B 7/04; G02B 27/00; G02B 27/01; H04N 23/55

(52) U.S. Cl. CPC G02B 13/0065; G02B 7/04; G02B 27/0093; H04N 23/55; G02B 27/0172

(57) ABSTRACT

Systems and techniques are described for redirecting light. For example, an apparatus for redirecting light can include a display positioned along a first optical axis. The first optical axis passes through a viewing plane of the display and intersects with a viewing position. The apparatus can include a first light redirecting element positioned along the first optical axis. The first light redirecting element is configured to redirect light from a scene toward a second optical axis. The apparatus includes an image sensor. The image sensor is configured to receive the light from the scene. The first light redirecting element is included along an optical path between the scene and the image sensor.

### FIELD

This present disclosure is generally related to optics. For example, aspects of the present disclosure relate to systems and techniques of folded optics for video pass-through.

### BACKGROUND

Many devices and systems allow a scene to be captured by generating images (also referred to as frames or photographs) and/or video data (including multiple frames) of the scene. For example, a camera or a device including a camera can capture a single image or a sequence of frames (e.g., a video) of a scene. In some cases, the image or sequence of frames can be processed for performing one or more functions, can be output for display, can be output for processing and/or consumption by other devices, among other uses.

In some cases, multiple cameras can simultaneously capture images and/or video frames of a scene with different field of view, pose, depth of field, resolution, focus, or the like. In some cases, viewing images from the multiple cameras can provide a greater perspective of the scene. For example, images from a first camera may capture details of individual players in a sporting event, while images from a second camera may capture multiple players on a team spread across a playing field, the crowd, and/or other details not captured by the images from the first camera.

Extended reality (XR) devices are another example of devices that can include one or more cameras. XR devices can include augmented reality (AR) devices, virtual reality (VR) devices, mixed reality (MR) devices, or the like. For instance, examples of AR devices include smart glasses and head-mounted displays (HMDs). In general, an AR device can implement cameras and a variety of sensors to track the position of the AR device and other objects within the physical environment. An AR device can use the tracking information to provide a user of the AR device a realistic AR experience. For example, an AR device can allow a user to experience or interact with immersive virtual environments or content. To provide realistic AR experiences, AR technologies generally aim to integrate virtual content with the physical world. In some examples, AR technologies can match the relative pose and movement of objects and devices. For example, an AR device can use tracking information to calculate the relative pose of devices, objects, and/or maps of the real-world environment in order to match the relative position and movement of the devices, objects, and/or the real-world environment. Using the pose and movement of one or more devices, objects, and/or the real-world environment, the AR device can anchor content to the real-world environment in a convincing manner. The relative pose information can be used to match virtual content with the user's perceived motion and the spatio-temporal state of the devices, objects, and real-world environment.

### SUMMARY

Systems and techniques are described herein for processing images. According to at least one example, a method is provided for redirecting light. The method includes: obtaining, at a first light redirecting element positioned along a first optical axis, light from a scene, wherein a viewing position is associated with a first optical path length, and wherein the first optical path length is associated with light passing through the first light redirecting element along the first optical axis; redirecting, by the first light redirecting element, the light from the scene toward a second optical axis; and capturing, by an image sensor, the light from the scene, wherein the image sensor is associated with a second optical path length, and wherein the second optical path length is associated with light redirected by the first light redirecting element toward the second optical axis.

In another example, an apparatus for redirecting light is provided. The apparatus includes a display positioned along a first optical axis, wherein the first optical axis passes through a viewing plane of the display and intersects with a viewing position a first light redirecting element positioned along the first optical axis, wherein the first light redirecting element is configured to redirect light from a scene toward a second optical axis; and an image sensor, wherein the image sensor is configured to receive the light from the scene and wherein the first light redirecting element is included along an optical path between the scene and the image sensor.

In another example, a non-transitory computer-readable medium is provided that has stored thereon instructions that, when executed by one or more processors, cause the one or more processors to: obtain, at a first light redirecting element positioned along a first optical axis, light from a scene, wherein a viewing position is associated with a first optical path length, and wherein the first optical path length is associated with light passing through the first light redirecting element along the first optical axis; redirect, by the first light redirecting element, the light from the scene toward a second optical axis; and capture, by an image sensor, the light from the scene, wherein the image sensor is associated with a second optical path length, and wherein the second optical path length is associated with light redirected by the first light redirecting element toward the second optical axis.

In accordance with another embodiment of the present disclosure, an apparatus for redirecting light is provided. The apparatus includes: means for obtaining, at a first light redirecting element positioned along a first optical axis, light from a scene, wherein a viewing position is associated with a first optical path length, and wherein the first optical path length is associated with light passing through the first light redirecting element along the first optical axis; means for redirecting, by the first light redirecting element, the light from the scene toward a second optical axis; and means for capturing, by an image sensor, the light from the scene, wherein the image sensor is associated with a second optical path length, and wherein the second optical path length is associated with light redirected by the first light redirecting element toward the second optical axis.

In some aspects, one or more of the apparatuses described herein is or is part of a camera, a mobile device (e.g., a mobile telephone or so-called “smart phone” or other mobile device), a wireless communication device, an extended reality device (e.g., a virtual reality (VR) device, an augmented reality (AR) device, or a mixed reality (MR) device), a wearable device, a personal computer, a laptop computer, a server computer, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing device, in accordance with some examples of the present disclosure;

FIG. 2 is a block diagram illustrating an architecture of an example extended reality (XR) system, in accordance with some examples of the present disclosure;

FIG. 3 is a block diagram illustrating an architecture of a simultaneous localization and mapping (SLAM) device, in accordance with some examples of the present disclosure;

FIG. 4A is a perspective diagram illustrating a head-mounted display (HMD) that performs feature tracking and/or VSLAM, in accordance with some examples;

FIG. 4B is a perspective diagram illustrating the HMD of FIG. 4A being worn by a user, in accordance with some examples;

FIG. 5A is a diagram illustrating a position offset between a viewing position and a camera position for a video pass-through system, in accordance with some examples;

FIG. 5B is an image of a scene illustrating artifacts from reprojection, in accordance with some examples;

FIG. 6A is a diagram illustrating a camera system utilizing light redirecting elements, in accordance with some examples;

FIG. 6B is a diagram illustrating a camera system utilizing a single light redirecting element, in accordance with some examples;

FIG. 6C is a diagram illustrating camera system utilizing two light redirecting elements, in accordance with some examples;

FIG. 7A illustrates a perspective view of an example configuration for a light redirecting element 700, in accordance with some examples;

FIG. 7B illustrates a cross-sectional view of additional example configuration for a light redirecting element 720, in accordance with some examples;

FIG. 7C illustrates a perspective view of an example configuration for a dual light redirecting element 740, in accordance with some examples;

FIG. 7D illustrates a cross-sectional view 760 of the dual light redirecting element 740 of FIG. 7C, in accordance with some examples;

FIG. 7E illustrates a cross-sectional view of an additional example configuration for a dual light redirecting element 780, in accordance with some examples;

FIG. 8A illustrates a perspective view of an example configuration for a concentric light redirecting element, in accordance with some examples;

FIG. 8B illustrates a cross-sectional view of the example configuration for the concentric light redirecting element of FIG. 8A, in accordance with some examples;

FIG. 8C illustrates a perspective view of an additional example configuration for a concentric light redirecting element, in accordance with some examples;

FIG. 8D illustrates a cross-sectional view of the example configuration for the concentric light redirecting element of FIG. 8C, in accordance with some examples;

FIG. 9A illustrates an example cross-sectional view of a concentric light redirecting element with a flat external surface and a flat reflective surface, in accordance with some examples;

FIG. 9B illustrates an example cross-sectional view of a concentric light redirecting element with a flat external surface and a convex reflective surface, in accordance with some examples;

FIG. 9C illustrates an example cross-sectional view of a concentric light redirecting element with a flat external surface and a concave reflective surface, in accordance with some examples;

FIG. 9D illustrates an example cross-sectional view of a concentric light redirecting element with a curved external surface and a flat reflective surface, in accordance with some examples;

FIG. 9E illustrates an example cross-sectional view of a concentric light redirecting element with a curved external surface and a concave reflective surface, in accordance with some examples;

FIG. 9F illustrates an additional example cross-sectional view of a concentric light redirecting element with a flat external surface and a concave reflective surface, in accordance with some examples;

FIG. 9G illustrates an example isometric view of the concentric light redirecting element of FIG. 9A, in accordance with some examples;

FIG. 9H illustrates an example isometric view 970 of the concentric light redirecting element of FIG. 9D, in accordance with some examples;

FIG. 10A illustrates an example configuration 1000 for an external facing display in a video see through system, in accordance with some examples;

FIG. 10B illustrates an example configuration 1030 for integrating a camera sensor with an external facing display using a light redirecting configuration, in accordance with some examples;

FIG. 10C illustrates an additional example configuration 1060 for integrating a camera sensor with an external facing display using a light redirecting configuration, in accordance with some examples;

FIG. 11A is a perspective diagram illustrating a front surface of a mobile handset that performs feature tracking and/or VSLAM using one or more front-facing cameras, in accordance with some examples;

FIG. 11B is a perspective diagram illustrating a rear surface of a mobile handset that performs feature tracking and/or VSLAM using one or more rear-facing cameras, in accordance with some examples;

FIG. 12 is a flow diagram illustrating an example of an image processing technique, in accordance with some examples;

FIG. 13 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A depth sensor is a sensor that measures a depth, range, or distance from the depth sensor to one or more portions of an environment that the depth sensor is in. Examples of depth sensors include light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, or combinations thereof. Depth data captured by depth sensors can include point clouds, 3D models, and/or depth images.

Extended reality (XR) systems or devices can provide virtual content to a user and/or can combine real-world views of physical environments (scenes) and virtual environments (including virtual content). XR systems facilitate user interactions with such combined XR environments. The real-world view can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

In some cases, the real-world view can be displayed to a user of an XR system on one or more “pass-through” displays. In the case of a pass-through display, a user's direct view of the real-world environment may be obscured by a display and/or other components of the XR system. In some implementations, one or more cameras can be provided to capture images of the real-world environment (e.g., a scene) and the captured images can be displayed on a display. In some cases, the images captured by the one or more cameras may be captured from a perspective that is different from how the user of an XR system would directly perceive the real-world environment. In some implementations, a digital reprojection can be used to depict the real-world environment in images captured by the one or more cameras from a perspective or viewpoint of a user's eyes.

In some cases, digital reprojection can introduce artifacts and/or errors in the reprojected images. In some aspects, digital reprojection can result in luminance and/or chrominance errors. In some examples, portions of the real-world environment that would be visible from the viewpoint of the user's eyes may be obscured from the viewpoint of the one or more cameras. In some implementations, a depth-based reprojection may be used to reproject the images captured by the one or more cameras. In some cases, determining the appropriate reprojection can be computationally intensive, which can result in a shortened battery life, reduced availability of computational resources, or the like.

In view of the above, systems and techniques are needed for providing pass-through images without the need for digital reprojection. For example, by removing the need for digital reprojection, computational costs, increased power consumption, artifacts, and/or errors associated with digital reprojection can be avoided. In some implementations, the need for a depth sensor may also be avoided.

Systems, apparatuses, processes (also referred to as methods), and computer-readable media (collectively referred to as “systems and techniques”) are described herein for providing pass-through display of a real-world environment from the viewpoint of the user's eyes using foldable optics. In some examples, foldable optics can be utilized to project the real-world environment image sensor (e.g., an image sensor of a camera) onto the viewpoint of the user's eyes. In one illustrative example, light can pass through an opening (e.g., a window) in the XR system and a light redirecting element (e.g., a mirror, a prism) placed between the real-world environment and the user's eyes can redirect the light from the real-world environment toward an image sensor. In some implementations, two or more light redirecting elements can be included along the optical path between the real-world environment and the image sensor. In some cases, one or more optical elements can be provided along the path traveled by the light from the real-world environment such that the image sensor captures images from a viewpoint equivalent to the viewpoint of a user's eyes.

In some examples, a display can be positioned along an optical axis between the real-world environment and a user's eye located at a viewing position. In some cases, a first light redirecting element can redirect light from the real-world environment along a second optical axis toward an image sensor. In some examples, a display can be positioned along an optical axis between the real-world environment and a user's eye located at a viewing position. In some cases, a first light redirecting element can redirect light from the real-world environment along a second optical axis. In some examples, a second light redirecting element can redirect light from the second optical axis along a third optical axis toward an image sensor.

In some cases, the display can be coupled to a first side of a printed circuit board (PCB) facing the user's eye and the image sensor can be coupled to a second side of the PCB opposite the first side of the PCB.

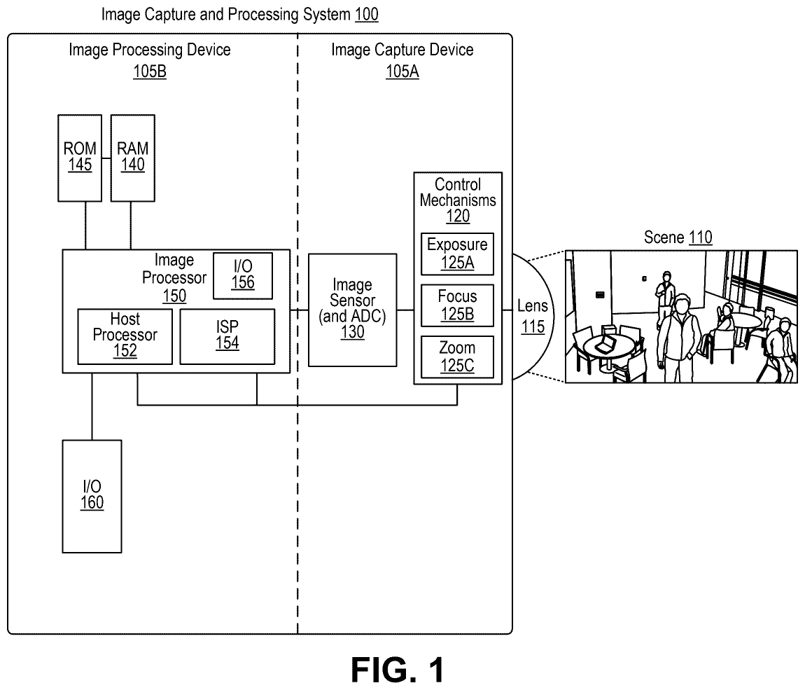

In some cases, the light redirecting element can have optical power and can supplement and/or replace the one or more optical elements. In one illustrative example, one or more surfaces of a light redirecting element may be implemented as a concave mirror, a convex mirror, a concave lens, a convex lens, an aspheric lens, or the like. In another illustrative example, the one or more optical elements can include a concave or convex aperture. Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), time of flight (ToF), structured light, stereoscopy, or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

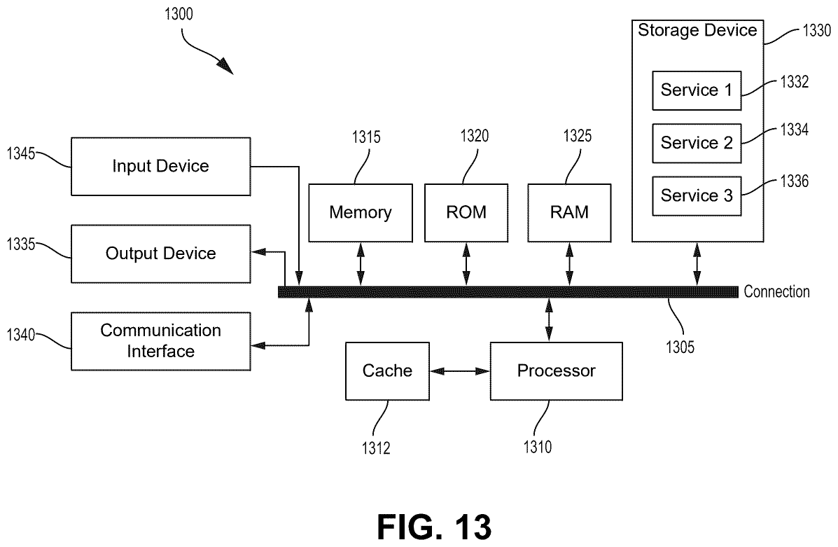

The image processor 150 may include one or more processors, such as one or more image signal processors (ISPs) (including ISP 154), one or more host processors (including host processor 152), and/or one or more of any other type of processor 1310 discussed with respect to the computing system 1300 of FIG. 13. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1325, read-only memory (ROM) 145/1320, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1335, any other input devices 1345, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image processing device 105B, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1002.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more or fewer components than those shown in FIG. 1. In some cases, the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

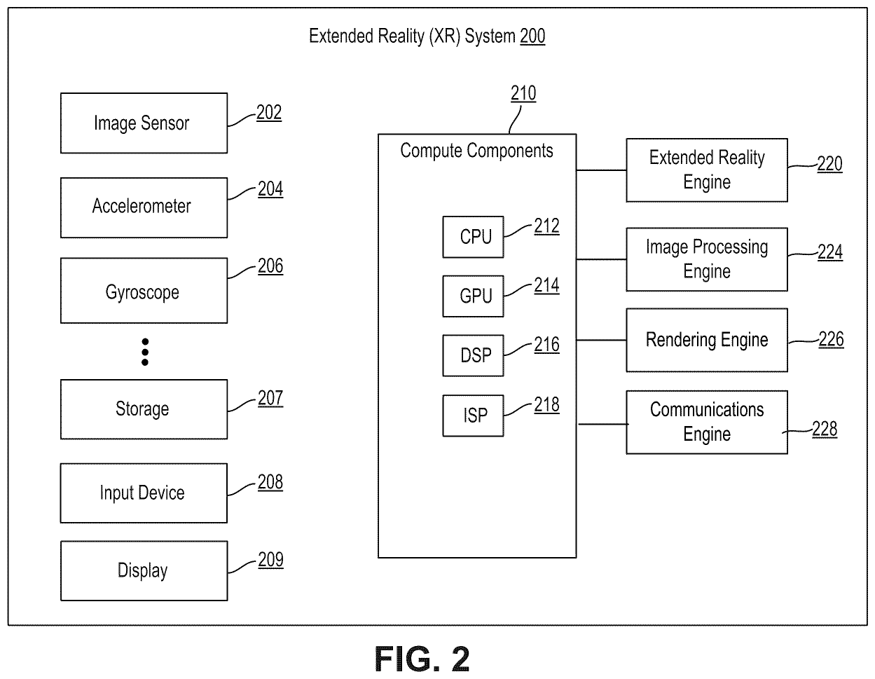

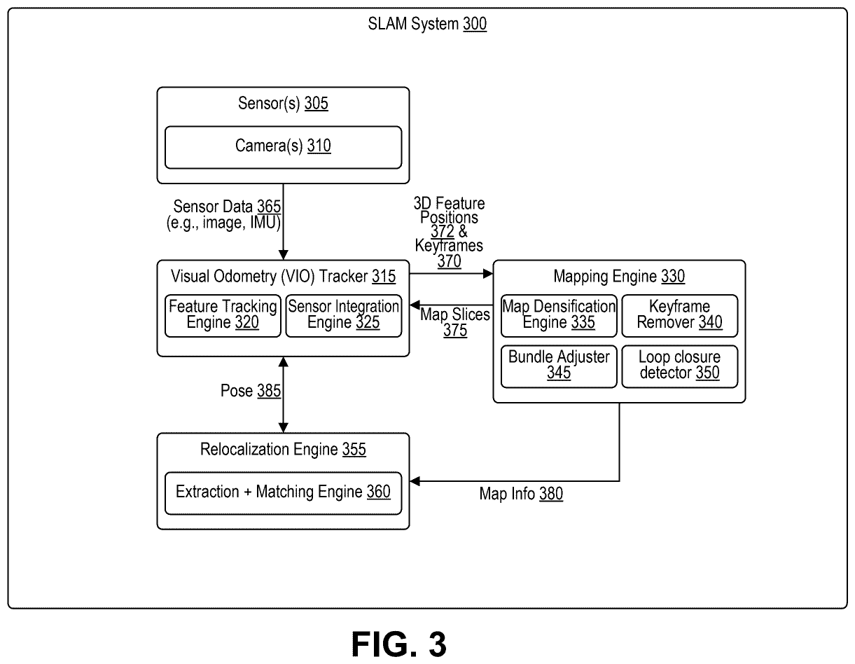

In some examples, the XR system 200 of FIG. 2 can include the image capture and processing system 100, the image capture device 105A, the image processing device 105B, or a combination thereof. In some examples, the simultaneous localization and mapping (SLAM) system 300 of FIG. 3 can include the image capture and processing system 100, the image capture device 105A, the image processing device 105B, or a combination thereof.

FIG. 2 is a diagram illustrating an architecture of an example XR system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, less, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1345 discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1340 of FIG. 13.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or SLAM techniques. For instance, the compute components 210 can perform SLAM or can be in communication (wired or wireless) with a SLAM system (not shown), such as the SLAM system 300 of FIG. 3. SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 3 is a block diagram illustrating an architecture of a SLAM system 300. In some examples, the SLAM system 300 can be, or can include, an XR system, such as the XR system 200 of FIG. 2. In some examples, the SLAM system 300 can be a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

The SLAM system 300 of FIG. 3 includes, or is coupled to, each of one or more sensors 305. The one or more sensors 305 can include one or more cameras 310. Each of the one or more cameras 310 may include an image capture device 105A, an image processing device 105B, an image capture and processing system 100, another type of camera, or a combination thereof. Each of the one or more cameras 310 may be responsive to light from a particular spectrum of light. The spectrum of light may be a subset of the electromagnetic (EM) spectrum. For example, each of the one or more cameras 310 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

The one or more sensors 305 can include one or more other types of sensors other than cameras 310, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the one or more sensors 305 can include any combination of sensors of the XR system 200 of FIG. 2.

The SLAM system 300 of FIG. 3 includes a visual-inertial odometry (VIO) tracker 315. The term visual-inertial odometry may also be referred to herein as visual odometry. The VIO tracker 315 receives sensor data 365 from the one or more sensors 305. For instance, the sensor data 365 can include one or more images captured by the one or more cameras 310. The sensor data 365 can include other types of sensor data from the one or more sensors 305, such as data from any of the types of sensors 305 listed herein. For instance, the sensor data 365 can include inertial measurement unit (IMU) data from one or more IMUs of the one or more sensors 305.

Upon receipt of the sensor data 365 from the one or more sensors 305, the VIO tracker 315 performs feature detection, extraction, and/or tracking using a feature tracking engine 320 of the VIO tracker 315. For instance, where the sensor data 365 includes one or more images captured by the one or more cameras 310 of the SLAM system 300, the VIO tracker 315 can identify, detect, and/or extract features in each image. Features may include visually distinctive points in an image, such as portions of the image depicting edges and/or corners. The VIO tracker 315 can receive sensor data 365 periodically and/or continually from the one or more sensors 305, for instance by continuing to receive more images from the one or more cameras 310 as the one or more cameras 310 capture a video, where the images are video frames of the video. The VIO tracker 315 can generate descriptors for the features. Feature descriptors can be generated at least in part by generating a description of the feature as depicted in a local image patch extracted around the feature. In some examples, a feature descriptor can describe a feature as a collection of one or more feature vectors. The VIO tracker 315, in some cases with the mapping engine 330 and/or the relocalization engine 355, can associate the plurality of features with a map of the environment based on such feature descriptors. The feature tracking engine 320 of the VIO tracker 315 can perform feature tracking by recognizing features in each image that the VIO tracker 315 already previously recognized in one or more previous images, in some cases based on identifying features with matching feature descriptors in different images. The feature tracking engine 320 can track changes in one or more positions at which the feature is depicted in each of the different images. For example, the feature extraction engine can detect a particular corner of a room depicted in a left side of a first image captured by a first camera of the cameras 310. The feature extraction engine can detect the same feature (e.g., the same particular corner of the same room) depicted in a right side of a second image captured by the first camera. The feature tracking engine 320 can recognize that the features detected in the first image and the second image are two depictions of the same feature (e.g., the same particular corner of the same room), and that the feature appears in two different positions in the two images. The VIO tracker 315 can determine, based on the same feature appearing on the left side of the first image and on the right side of the second image that the first camera has moved, for example if the feature (e.g., the particular corner of the room) depicts a static portion of the environment.

The VIO tracker 315 can include a sensor integration engine 325. The sensor integration engine 325 can use sensor data from other types of sensors 305 (other than the cameras 310) to determine information that can be used by the feature tracking engine 320 when performing the feature tracking. For example, the sensor integration engine 325 can receive IMU data (e.g., which can be included as part of the sensor data 365) from an IMU of the one or more sensors 305. The sensor integration engine 325 can determine, based on the IMU data in the sensor data 365, that the SLAM system 300 has rotated 15 degrees in a clockwise direction from acquisition or capture of a first image to acquisition or capture of the second image by a first camera of the cameras 310. Based on this determination, the sensor integration engine 325 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 320 can take this expectation into consideration in tracking features between the first image and the second image.

Based on the feature tracking by the feature tracking engine 320 and/or the sensor integration by the sensor integration engine 325, the VIO tracker 315 can determine a 3D feature positions 372 of a particular feature. The 3D feature positions 372 can include one or more 3D feature positions and can also be referred to as 3D feature points. The 3D feature positions 372 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. The VIO tracker 315 can also determine one or more keyframes 370 (referred to hereinafter as keyframes 370) corresponding to the particular feature. In some examples, a keyframe (from the one or more keyframes 370) corresponding to a particular feature may be an image in which the particular feature is clearly depicted. In some examples, a keyframe corresponding to a particular feature may be an image that reduces uncertainty in the 3D feature positions 372 of the particular feature when considered by the feature tracking engine 320 and/or the sensor integration engine 325 for determination of the 3D feature positions 372. In some examples, a keyframe corresponding to a particular feature also includes data about the pose 385 of the SLAM system 300 and/or the camera(s) 310 during capture of the keyframe. In some examples, the VIO tracker 315 can send 3D feature positions 372 and/or keyframes 370 corresponding to one or more features to the mapping engine 330. In some examples, the VIO tracker 315 can receive map slices 375 from the mapping engine 330. The VIO tracker 315 can extract feature information within the map slices 375 for feature tracking using the feature tracking engine 320.

Based on the feature tracking by the feature tracking engine 320 and/or the sensor integration by the sensor integration engine 325, the VIO tracker 315 can determine a pose 385 of the SLAM system 300 and/or of the cameras 310 during capture of each of the images in the sensor data 365. The pose 385 can include a location of the SLAM system 300 and/or of the cameras 310 in 3D space, such as a set of coordinates along three different axes that are perpendicular to one another (e.g., an X coordinate, a Y coordinate, and a Z coordinate). The pose 385 can include an orientation of the SLAM system 300 and/or of the cameras 310 in 3D space, such as pitch, roll, yaw, or some combination thereof. In some examples, the VIO tracker 315 can send the pose 385 to the relocalization engine 355. In some examples, the VIO tracker 315 can receive the pose 385 from the relocalization engine 355.

The SLAM system 300 also includes a mapping engine 330. The mapping engine 330 generates a 3D map of the environment based on the 3D feature positions 372 and/or the keyframes 370 received from the VIO tracker 315. The mapping engine 330 can include a map densification engine 335, a keyframe remover 340, a bundle adjuster 345, and/or a loop closure detector 350. The map densification engine 335 can perform map densification, in some examples, increase the quantity and/or density of 3D coordinates describing the map geometry. The keyframe remover 340 can remove keyframes, and/or in some cases add keyframes. In some examples, the keyframe remover 340 can remove keyframes 370 corresponding to a region of the map that is to be updated and/or whose corresponding confidence values are low. The bundle adjuster 345 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 350 can recognize when the SLAM system 300 has returned to a previously mapped region, and can use such information to update a map slice and/or reduce the uncertainty in certain 3D feature points or other points in the map geometry. The mapping engine 330 can output map slices 375 to the VIO tracker 315. The map slices 375 can represent 3D portions or subsets of the map. The map slices 375 can include map slices 375 that represent new, previously-unmapped areas of the map. The map slices 375 can include map slices 375 that represent updates (or modifications or revisions) to previously-mapped areas of the map. The mapping engine 330 can output map information 380 to the relocalization engine 355. The map information 380 can include at least a portion of the map generated by the mapping engine 330. The map information 380 can include one or more 3D points making up the geometry of the map, such as one or more 3D feature positions 372. The map information 380 can include one or more keyframes 370 corresponding to certain features and certain 3D feature positions 372.

The SLAM system 300 also includes a relocalization engine 355. The relocalization engine 355 can perform relocalization, for instance when the VIO tracker 315 fail to recognize more than a threshold number of features in an image, and/or the VIO tracker 315 loses track of the pose 385 of the SLAM system 300 within the map generated by the mapping engine 330. The relocalization engine 355 can perform relocalization by performing extraction and matching using an extraction and matching engine 360. For instance, the extraction and matching engine 360 can extract features from an image captured by the cameras 310 of the SLAM system 300 while the SLAM system 300 is at a current pose 385, and can match the extracted features to features depicted in different keyframes 370, identified by 3D feature positions 372, and/or identified in the map information 380. By matching these extracted features to the previously-identified features, the relocalization engine 355 can identify that the pose 385 of the SLAM system 300 is a pose 385 at which the previously-identified features are visible to the cameras 310 of the SLAM system 300, and is therefore similar to one or more previous poses 385 at which the previously-identified features were visible to the cameras 310. In some cases, the relocalization engine 355 can perform relocalization based on wide baseline mapping, or a distance between a current camera position and camera position at which feature was originally captured. The relocalization engine 355 can receive information for the pose 385 from the VIO tracker 315, for instance regarding one or more recent poses of the SLAM system 300 and/or cameras 310, which the relocalization engine 355 can base its relocalization determination on. Once the relocalization engine 355 relocates the SLAM system 300 and/or cameras 310 and thus determines the pose 385, the relocalization engine 355 can output the pose 385 to the VIO tracker 315.

In some examples, the VIO tracker 315 can modify the image in the sensor data 365 before performing feature detection, extraction, and/or tracking on the modified image. For example, the VIO tracker 315 can rescale and/or resample the image. In some examples, rescaling and/or resampling the image can include downscaling, downsampling, subscaling, and/or subsampling the image one or more times. In some examples, the VIO tracker 315 modifying the image can include converting the image from color to greyscale, or from color to black and white, for instance by desaturating color in the image, stripping out certain color channel(s), decreasing color depth in the image, replacing colors in the image, or a combination thereof. In some examples, the VIO tracker 315 modifying the image can include the VIO tracker 315 masking certain regions of the image. Dynamic objects can include objects that can have a changed appearance between one image and another. For example, dynamic objects can be objects that move within the environment, such as people, vehicles, or animals. A dynamic objects can be an object that have a changing appearance at different times, such as a display screen that may display different things at different times. A dynamic object can be an object that has a changing appearance based on the pose of the camera(s) 310, such as a reflective surface, a prism, or a specular surface that reflects, refracts, and/or scatters light in different ways depending on the position of the camera(s) 310 relative to the dynamic object. The VIO tracker 315 can detect the dynamic objects using facial detection, facial recognition, facial tracking, object detection, object recognition, object tracking, or a combination thereof. The VIO tracker 315 can detect the dynamic objects using one or more artificial intelligence algorithms, one or more trained machine learning models, one or more trained neural networks, or a combination thereof. The VIO tracker 315 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

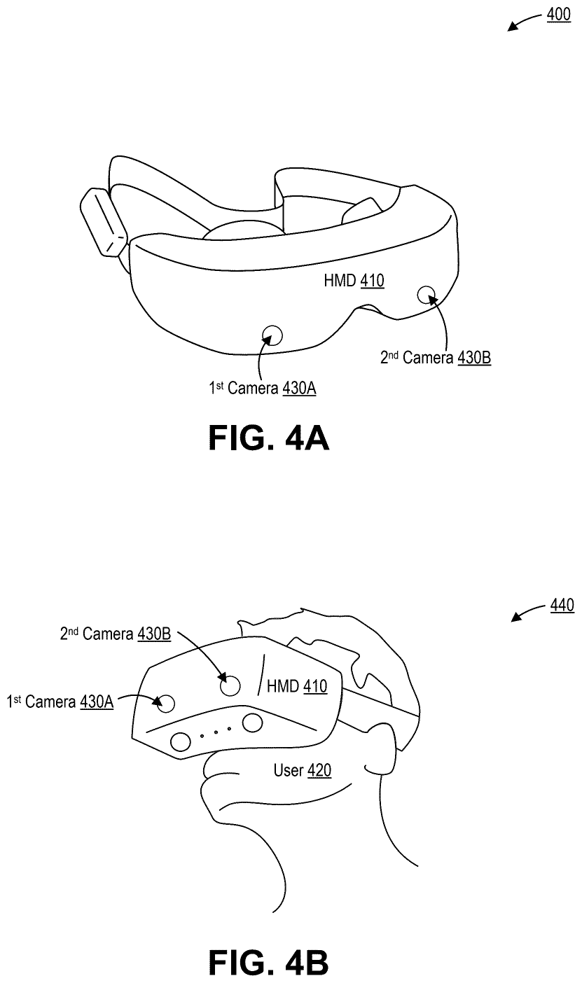

FIG. 4A is a perspective diagram 400 illustrating a HMD 410 that performs feature tracking and/or visual simultaneous localization and mapping (VSLAM), in accordance with some examples. The HMD 410 may be, for example, an augmented reality (AR) headset, a virtual reality (VR) headset, a mixed reality (MR) headset, an extended reality (XR) headset, or some combination thereof. The HMD 410 may be an example of an XR system 200, a SLAM system 300, or a combination thereof. The HMD 410 includes a first camera 430A and a second camera 430B along a front portion of the HMD 410. The first camera 430A and the second camera 430B may be two of image sensor 202. In some examples, the HMD 410 may only have a single camera. In some examples, the HMD 410 may include one or more additional cameras in addition to the first camera 430A and the second camera 430B. In some examples, the HMD 410 may include one or more additional sensors in addition to the first camera 430A and the second camera 430B.

FIG. 4B is a perspective diagram 440 illustrating the HMD 410 of FIG. 4A being worn by a user 420, in accordance with some examples. The user 420 wears the HMD 410 on the user 420's head over the user 420's eyes. The HMD 410 can capture images with the first camera 430A and the second camera 430B. In some examples, the HMD 410 displays one or more display images toward the user 420's eyes that are based on the images captured by the first camera 430A and the second camera 430B. The display images may provide a stereoscopic view of the environment, in some cases with information overlaid and/or with other modifications. For example, the HMD 410 can display a first display image to the user 420's right eye, the first display image based on an image captured by the first camera 430A. The HMD 410 can display a second display image to the user 420's left eye, the second display image based on an image captured by the second camera 430B. For instance, the HMD 410 may provide overlaid information in the display images overlaid over the images captured by the first camera 430A and the second camera 430B.

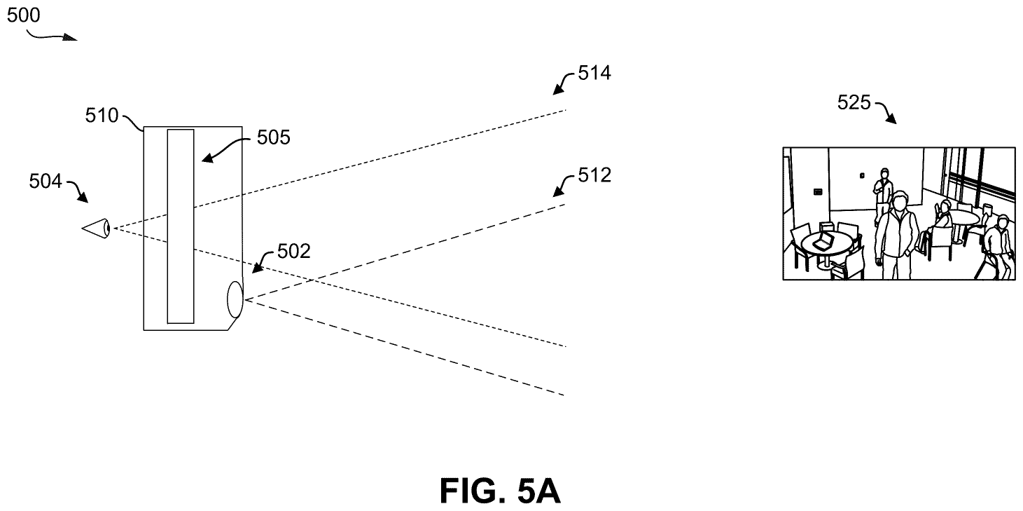

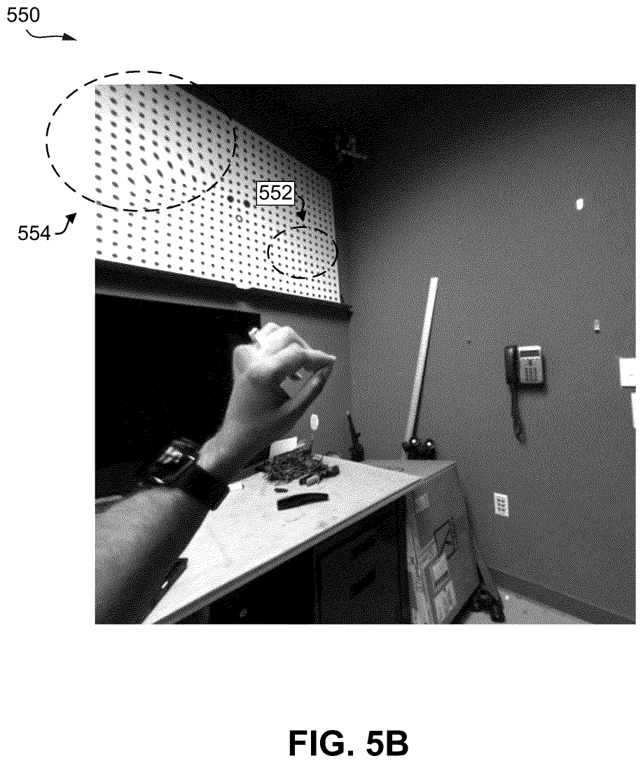

The HMD 410 includes no wheels, propellers, or other conveyance of its own. Instead, the HMD 410 relies on the movements of the user 420 to move the HMD 410 about the environment. Thus, in some cases, the HMD 410, when performing a SLAM technique, can skip path planning using a path planning engine and/or movement actuation using the movement actuator. In some cases, the HMD 410 can still perform path planning using a path planning engine, and can indicate directions to follow a suggested path to the user 420 to direct the user along the suggested path planned using the path planning engine. In some cases, for instance where the HMD 410 is a VR headset, the environment may be entirely or partially virtual. If the environment is at least partially virtual, then movement through the virtual environment may be virtual as well. For instance, movement through the virtual environment can be controlled by an input device (e.g., input device 208 of FIG. 2). The movement actuator may include any such input device. Movement through the virtual environment may not require wheels, propellers, legs, or any other form of conveyance. If the environment is a virtual environment, then the HMD 410 can still perform path planning using the path planning engine and/or movement actuation. If the environment is a virtual environment, the HMD 410 can perform movement actuation using the movement actuator by performing a virtual movement within the virtual environment. Even if an environment is virtual, SLAM techniques may still be valuable, as the virtual environment can be unmapped and/or may have been generated by a device other than the HMD 410, such as a remote server or console associated with a video game or video game platform. In some cases, feature tracking and/or SLAM may be performed in a virtual environment even by vehicle or other device that has its own physical conveyance system that allows it to physically move about a physical environment. For example, SLAM may be performed in a virtual environment to test whether (e.g., a SLAM system 300 of FIG. 3, HMD 510 of FIG. 5A) is working properly without wasting time or energy on movement and without wearing out a physical conveyance system.

FIG. 5A is a diagram 500 illustrating a position offset between a viewing position and a camera position for a video pass-through system. As illustrated in FIG. 5A, a HMD 510 can include a camera 502 mounted within a housing of the HMD 510. The HMD 510 may be, for example, an AR headset, a VR headset, a MR headset, an XR headset, or some combination thereof. The HMD 510 may be an example of an XR system 200, a SLAM system 300, HMD 410 of FIG. 4A and FIG. 4B, or a combination thereof. In the example of FIG. 5A, the HMD 510 can include a display 505 positioned relative to a viewing position 504 (e.g., a user's eye position). As illustrated in FIG. 5A, the viewing position 504 may also be associated with a field of view (FOV) 514. In some cases, the display 505 may obstruct the FOV 514, including a scene 525 as shown in FIG. 5A.

In some examples, the camera 502 can be used to provide video pass-through to a user by displaying images of the real world on a display 505. In some implementations, the camera 502 can capture images of the scene 525 as viewed from the pose of the camera 502. For example, the camera 502 can capture images of a portion of the scene 525 falling within the FOV 512 of the camera 502. As illustrated in FIG. 5A, the offset of the camera 502 from the viewing position 504 may result in an image displayed on the display 505 that does not reflect what a user may see (e.g., from the viewing position 504) in the absence of the HMD 510. In some cases, a digital reprojection technique can be utilized to adjust images captured by the camera 502 to compensate for the offset between the camera 502 and the viewing position 504. However, digital reprojection may result in visual artifacts that may also interfere with the immersion of user with an XR experience. In some implementations, digital reprojection may also require the use of a depth sensor to gather depth information that can be utilized to determine the appropriate reprojection from the perspective of the camera 502 to the perspective of the viewing position 504.

FIG. 5B is an image of a scene 550 illustrating artifacts from reprojection caused by an offset between a viewing position and a camera position for an HMD. In the example of FIG. 5B, a portion of the scene 550 includes a panel with an array of evenly spaced holes. In some cases, digital reprojection of a pattern of evenly spaced holes may be reproduced accurately by a digital reprojection technique as shown by the region 552 of the scene 550. However, in some cases, digital reprojection may produce errors in luminance, chrominance, and/or other distortions of the scene 550 as shown by the region 554 of the scene 550. In one illustrative example, the image of the scene 550 may include color artifacts. In some cases, color artifacts may be avoided by transforming the image to a black and white color representation prior to attempting digital reprojection. In some cases, digital reprojection can produce artifacts when depth information (e.g., captured by a depth sensor) is incorrect. For example, a depth sensor may be offset from a camera (e.g., camera 502 of FIG. 5A), which may introduce incorrect depth measurements relative to the camera position. In some cases, digital reprojection may lack information about portions of the scene 550 that would otherwise be visible from a user's eye position (e.g., the viewing position 504 of FIG. 5A) but were obstructed by an image captured by a camera (e.g., camera 502 of FIG. 5A) offset from the viewing position (e.g., viewing position 504 of FIG. 5A). In some aspects, digital reprojection may be computationally intensive, require large amounts of memory, consume additional power, or any combination thereof.

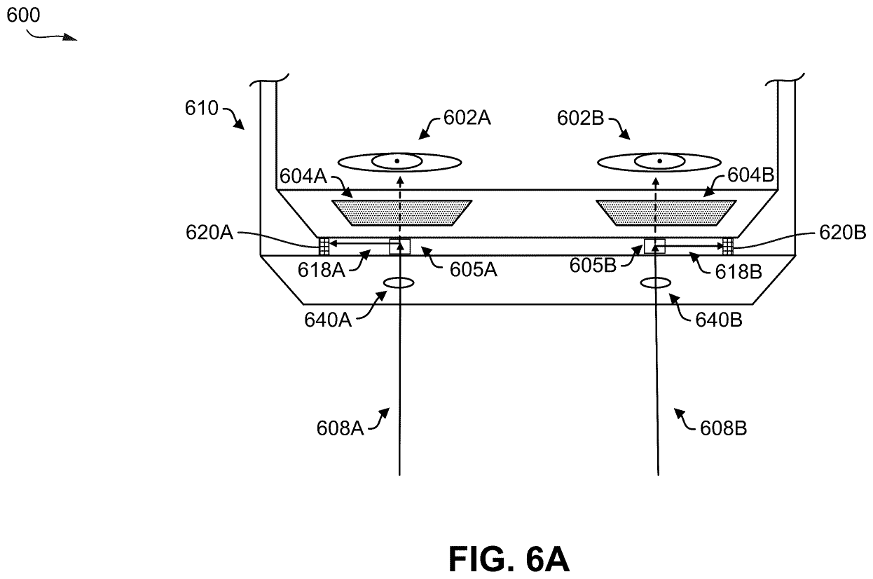

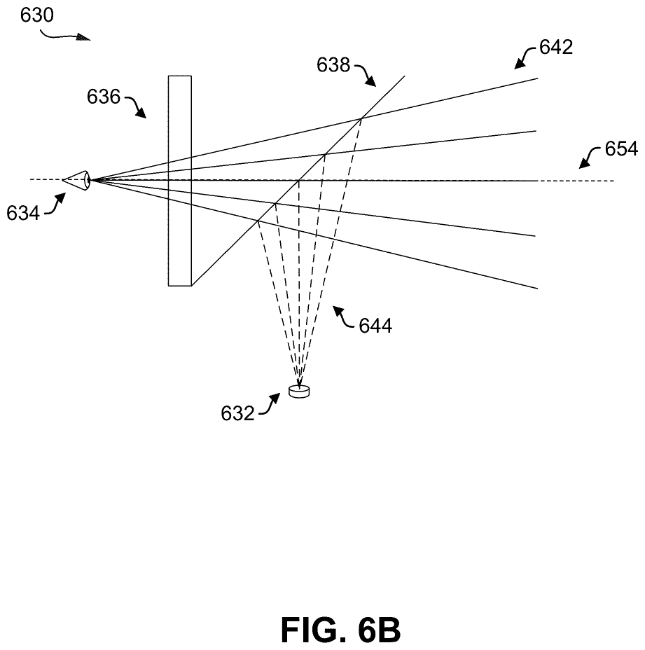

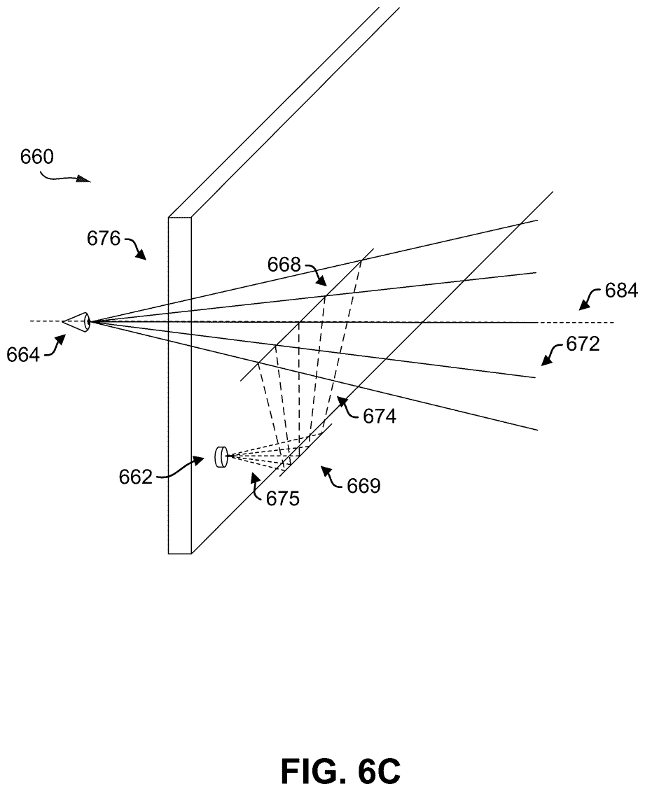

FIG. 6A through FIG. 6C are diagrams illustrating example camera systems utilizing light redirecting elements. In some cases, the example camera systems shown in FIG. 6A through FIG. 6C can be configured to project (e.g., optically project) a viewing position (e.g., viewing position 504 of FIG. 5A) on to a position of an image sensor (e.g., image sensor 130 of FIG. 1, image sensor 202 of FIG. 2, one or more cameras 310 of FIG. 3.

FIG. 6A is a diagram illustrating an example camera system 600 utilizing light redirecting elements. In the example of FIG. 6A, a HMD 610 includes a pair of displays 604A, 604B, light redirecting elements 605A, 605B, image sensors 620A, 620B, camera ports 640A, 640B. As illustrated the display 604A, light redirecting element 605A, optical axis 608A, redirected optical axis 618A, image sensor 620A, and camera port 640A can be associated with a first viewing position 602A (e.g., a user's right eye position). Similarly, the display 604B, light redirecting element 605B, optical axis 608B, redirected optical axis 618B, image sensor 620B, and camera port 640B can be associated with a second viewing position 602B (e.g., a user's left eye position).

In some cases, incoming light from a scene (e.g., scene 550 of FIG. 5B) may be incident upon the camera port 640A. In some cases, the light from the scene may be redirected by the light redirecting element 605A (e.g., a prism, mirror, or the like) away from an optical axis 608A and toward a redirected optical axis 618A. In the illustrated example of FIG. 6A, the optical axis 608A and the redirected optical axis 618A may intersect one another to form an angle. In some cases, the optical axis 608A and the redirected optical axis 618A may be perpendicular (e.g., intersect at a right angle). In some cases, the optical axis 608A may pass through the camera port 640A, the light redirecting element 605A, the display 604A, and the first viewing position 602A. Similarly, the optical axis 608B may pass through the camera port 640B, the light redirecting element 605B, the display 604B, and the second viewing position 602B.

In some implementations, the displays 604A, 604B may be opaque (e.g., in the visible light spectrum). In some cases, the image sensors 620A, 620B may be configured to capture light from a scene, which can in turn be reprojected onto the displays 604A, 604B and viewed from the respective viewing positions 602A, 602B.

In some cases, the displays 604A, 604B may be at least partially transmissive of light (e.g., in the visible light spectrum) such that light from a scene may be visible directly from the respective viewing positions 602A, 602B. In one illustrative example, the displays 604A, 604B may be transparent. In some aspects, the displays 604A, 604B may include transparent regions, translucent regions, opaque regions, and/or any combination thereof. In some cases, images of a scene captured by the image sensors 620A, 620B may be reprojected onto the display to supplement a user's view of a scene through the displays 604A, 604B. In one illustrative example, images of a scene captured during low light, fog, haze, and/or any other visual obstruction by the image sensors 620A, 620B may be reprojected onto the display to supplement a user's view of the scene.

As illustrated in FIG. 6A, the light redirecting element 605A can redirect the light from the optical axis 608A along the redirected optical axis 618A and toward the image sensor 620A. Similarly, the light redirecting element 605B can redirect the light from the optical axis 608B along the redirected optical axis 618B and toward the image sensor 620B. In some cases, each respective optical system between the scene and respective image sensors 620A, 620B can be configured to project the respective viewing positions 602A, 602B onto the position of the respective image sensors 620A, 620B. In some cases, projecting the viewing positions 602A, 602B onto the positions of the respective image sensors 620A, 620B may reduce discrepancies in the distances traveled by light from the scene that arrives at the respective image sensors 620A, 620B, relative to distances between the scene and the first viewing position 602A and second viewing position 602B, respectively. In some implementations, a distance between the light redirecting element 605A and the image sensor 620A may be configured to match a distance between the light redirecting element 605A and the first viewing position 602A. Similarly, a distance between the light redirecting element 605B and the image sensor 620B may be configured to match a distance between the light redirecting element 605B and the second viewing position 602B. For example, in some cases, the distance between the light redirecting element 605A and the image sensor 620A may be less than 2 centimeter (cm). Similarly, the distance between the light redirecting element 605B and the image sensor 620B may be less than 2 centimeter (cm).

In some implementations, the HMD 610 may include one or more motors, actuators, piezoelectric components, or the like (not shown) configured to adjust the respective position of the respective image sensors 620A, 620B to adjust one or more of the distances between light redirecting elements 605A, 605B and the respective image sensors 620A, 620B. For example, the HMD 610 may obtain measurements of a user eye position relative to the HMD 610. In some cases, the respective position of the respective image sensors 620A, 620B may be adjusted to project the respective image sensors 620A, 620B onto the first viewing position 602A and the second viewing position 602B, respectively. In some examples, one or more optical components (not shown) may be configured to focus light from the scene on the respective image sensors 620A, 620B after being moved.

In some cases, the light redirecting element 605A, the light redirecting element 605B, the image sensor 620A and/or the image sensor 620B may be configured to be attached to a backside of a PCB (not shown) on an opposite side of the PCB from the displays 604A, 604B. In some cases, the light redirecting element 605A, the light redirecting element 605B, the image sensor 620A and/or the image sensor 620B may be configured to be attached to a housing of the HMD 610.

For the purposes of simplicity, certain elements of an optical system that includes the light redirecting elements 605A and/or light redirecting element 605B have been excluded from the example camera system 600 of FIG. 6A. For example, the camera system 600 shown in FIG. 6A does not show any lenses that may be utilized to focus an image at the focal plane of the image sensor 620A and/or image sensor 620B. However, it should be understood that an optical system may include lenses and/or other optical elements for focusing an image at the focal plane of the image sensor 620A and/or image sensor 620B.

FIG. 6B is a diagram illustrating an example camera system 630 utilizing a single light redirecting element. In some cases, the example camera system 630 may be included in an AR headset, a VR headset, a MR headset, an XR headset, HMD 410 of FIG. 4A and FIG. 4B, HMD 510 of FIG. 5A, HMD 610 of FIG. 6A, or some combination thereof. In the example of FIG. 6B, incoming light rays 642 may originate from a scene (e.g., scene 550 of FIG. 5B). In some cases, a light redirecting element 638 may be aligned to an optical axis 654 that passes through a viewing position 634 (e.g., the position of a user's eye). In some cases, the light redirecting element 638 may include a prism and/or mirror. As shown in FIG. 6B, the incoming light rays 642 are shown converging at the viewing position 634 to indicate that the incoming light rays 642 represent what a user may see in the absence of a display 636 that obstructs the view of the scene. FIG. 6B illustrates redirected light rays 644 that are redirected from the path of the incoming light rays 642. In one illustrative example, the light redirecting element 638 can be configured to redirect the incoming light rays 642 at a right angle (e.g., 90 degrees) to the optical axis 654 passing through the light redirecting element 638 and the viewing position 634. However, in some implementations, the light redirecting element 638 may redirect the incoming light rays 642 at an angle less than or greater than 90 degrees without departing from the scope of the present disclosure. As illustrated in FIG. 6B, the redirected light rays 644 may converge at an image sensor 632 that captures images of the scene. As noted above, an optical system that includes the light redirecting element 638 may be configured to project the viewing position 634 onto the image sensor 632. Accordingly, in some cases, an optical system that includes one or more light redirecting elements may include the light redirecting element 638, one or more lenses (not shown) and/or one or more optical elements (not shown).

FIG. 6C is a diagram illustrating an example camera system 660 utilizing two light redirecting elements. In some cases, the example camera system 660 may be included in an AR headset, a VR headset, a MR headset, an XR headset, HMD 410 of FIG. 4A and FIG. 4B, HMD 510 of FIG. 5A, HMD 610 of FIG. 6A, or some combination thereof. In the example of FIG. 6C, incoming light rays 672 may originate from a scene (e.g., scene 525 of FIG. 5A, scene 550 of FIG. 5B). In some cases, a first light redirecting element 668 may be aligned to an optical axis 684 that passes through a viewing position 664 (e.g., the position of a user's eye). In some cases, the first light redirecting element 668 may include a prism and/or mirror. As shown in FIG. 6C, the light rays 672 are shown converging at the viewing position 664 to indicate that the light rays 672 represent what a user may see in the absence of a display 676 that obstructs the view of the scene. FIG. 6C illustrates first redirected light rays 674 that are redirected from the path of the light rays 672. In one illustrative example, the first light redirecting element 668 can be configured to redirect the light rays 672 at a right angle to the optical axis 684 passing through the first light redirecting element 668 and the viewing position 664. However, in some implementations, the first light redirecting element 668 may redirect the light rays 672 at an angle less than or greater than 90 degrees without departing from the scope of the present disclosure. As illustrated in FIG. 6C, a second light redirecting element 669 may be included along the path of the first redirected light rays 674 and configured to redirect the first redirected light rays 674 in the direction of the second redirected light rays 675. For example, as illustrated, the second light redirecting element 669 can redirect the second redirected light rays 675 toward an image sensor 662. As illustrated in FIG. 6C, the second redirected light rays 675 may converge at an image sensor 662 that captures images of the scene. As noted above, an optical system that includes the first light redirecting element 668 and/or the second light redirecting element 669 may be configured to project the viewing position 664 onto the image sensor 662. In some cases, an optical system that includes one or more light redirecting elements may include the first light redirecting element 668, the second light redirecting element 669, one or more lenses (not shown) and/or one or more optical elements (not shown).

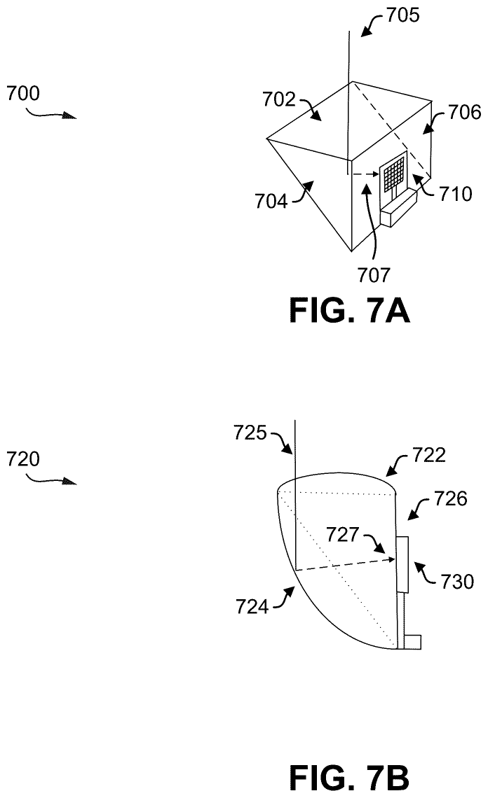

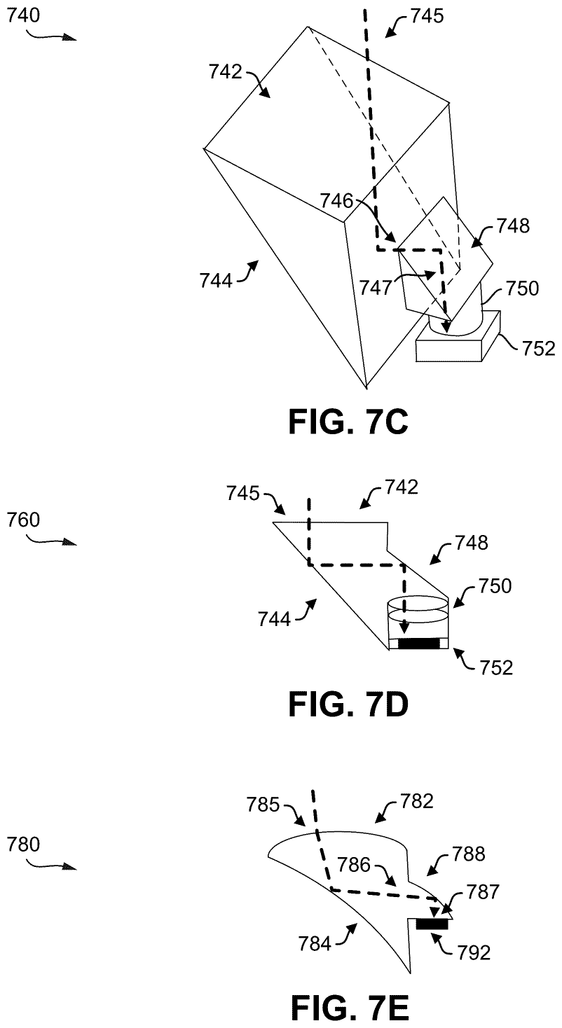

FIG. 7A illustrates a perspective view of an example configuration for a light redirecting element 700. In some cases, the light redirecting element 700 can correspond to the light redirecting element 605A of FIG. 6A, the light redirecting element 605B of FIG. 6A, the light redirecting element 638 of FIG. 6B, or the like. In the example of FIG. 7A, the light redirecting element 700 may be implemented as a prism with an external facing surface 702 and a light redirecting surface 704. As illustrated in FIG. 7A, a light ray 705 incident from a scene may reflect from the light redirecting surface 704 of the light redirecting element toward a redirected optical axis 707. In the illustrated example of FIG. 7A, an image sensor 710 is shown integrated to an image sensor surface 706 of the light redirecting element 700. In some cases, an optical system (not shown) may be included to focus light onto a focal plane of the image sensor 710. In some cases, conductive wires and/or other circuitry may be coupled to the image sensor surface 706 of the light redirecting element 700.

FIG. 7B illustrates a cross-sectional view of additional example configuration for a light redirecting element 720. In some cases, the light redirecting element 720 can correspond to the light redirecting element 605A of FIG. 6A, the light redirecting element 605B of FIG. 6A, the light redirecting element 638 of FIG. 6B, or the like. In the illustrated example of FIG. 7B, the light redirecting element 720 differs from the light redirecting element 700 of FIG. 7A in that the external surface 722 of the light redirecting element 720 is curved to provide optical power that can contribute to focusing light at the image sensor 730 attached to the image sensor surface 726 of the light redirecting element 720. As illustrated in FIG. 7B, a light ray 725 incident from a scene may be refracted by the external surface 722 and redirected by the light redirecting surface 724 toward a redirected optical axis 727. Further, as shown in FIG. 7B, a light redirecting surface 724 of the light redirecting element 720 may also be curved to provide optical power that can contribute to focusing light at the image sensor 730. In some cases, an optical system for focusing light onto a focal plane of the image sensor 730 may include the external surface 722, light redirecting surface 724, one or more additional optical elements (not shown), or any combination thereof without departing from the scope of the present disclosure. In some cases, conductive wires and/or other circuitry may be coupled to the image sensor surface 726 of the light redirecting element 720.

FIG. 7C illustrates a perspective view of an example configuration for a dual light redirecting element 740. In some cases, the light redirecting element 740 can correspond to the light redirecting element 605A of FIG. 6A, the light redirecting element 605B of FIG. 6A, the first light redirecting element 668 of FIG. 6C, the second light redirecting element 669 of FIG. 6C, or a combination thereof. In the example of FIG. 7A, the light redirecting element 740 may be implemented as a prism with an external facing surface 742, a first light redirecting surface 744, and a second light redirecting surface 748. As illustrated in FIG. 7C, a light ray 745 incident from a scene may reflect from the first light redirecting surface 744 of the light redirecting element 740 toward a first redirected optical axis 746. In some cases, light reflected from the first light redirecting surface 744 may be redirected by the second light redirecting surface 748 of the light redirecting element 740 toward a second redirected optical axis 747. In the illustrated example of FIG. 7C, an image sensor 752 is shown integrated the light redirecting element 740 such that the image sensor 752 is aligned to the second redirected optical axis 747. In some cases, an optical system 750 may be included to focus light onto a focal plane of the image sensor 752. In some cases, conductive wires and/or other circuitry may be coupled to the image sensor surface 746 of the light redirecting element 700. FIG. 7D illustrates a cross-sectional view 760 of the dual light redirecting element 740 of FIG. 7C.

FIG. 7E illustrates a cross-sectional view of an additional example configuration for a dual light redirecting element 780. The dual light redirecting element 780 of FIG. 7E differs from the light redirecting element 740 of FIG. 7C and FIG. 7D in that the external surface 782, the first light redirecting surface 784, and/or the second light redirecting surface 788 may be curved to provide optical power that can contribute to focusing light at the image sensor 792. As illustrated in FIG. 7E, a light ray 785 incident from a scene may be refracted by the external surface 782, reflected by the first light redirecting surface 784 toward a first redirected optical axis 786, and reflected by the second light redirecting surface 788 toward a second redirected optical axis 787. In some cases, the optical power provided by one or more of the external surface 782, first light redirecting surface 784, and/or second light redirecting surface 788 may form a complete optical system for focusing light at a focal plane of the image sensor 792. However, in some implementations an optical system may include the external surface 782, first light redirecting surface 784, and/or second light redirecting surface 788, one or more additional optical elements (not shown), or any combination thereof without departing from the scope of the present disclosure.

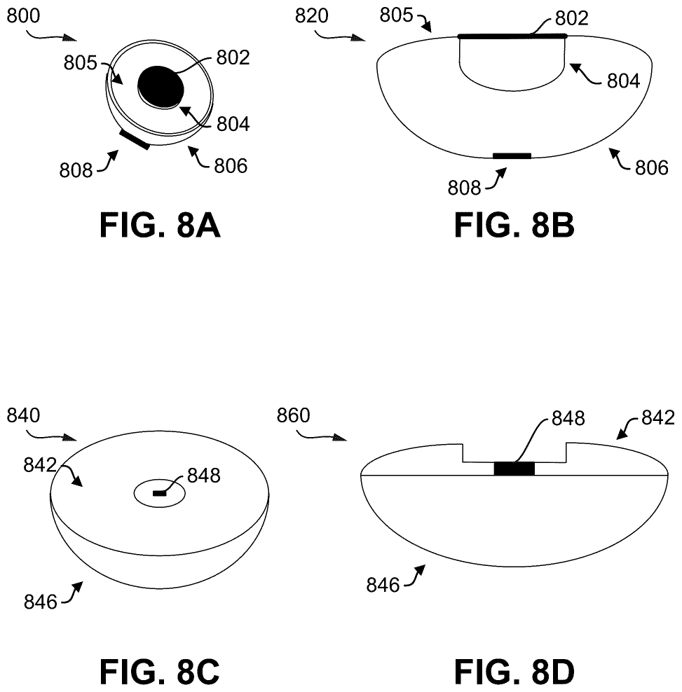

FIG. 8A illustrates a perspective view of an example configuration for a concentric light redirecting element 800. As illustrated in FIG. 8A, the concentric light redirecting element 800 may include a light blocking element 802 that blocks a back surface of a second light redirecting element 804 (e.g., a secondary mirror) of the concentric light redirecting element 800. In some cases, light incident on an external surface 805 of the concentric light redirecting element 800 can be redirected by a first light redirecting element 806 (e.g., a primary mirror) toward the second light redirecting element 804. In some examples, the second light redirecting element 804 may redirect light from the first light redirecting element 806 toward an image sensor 808. In some cases, an optical system including the second light redirecting element 804 and the first light redirecting element 806 may include one or more optical elements (not shown) configured to focus light at a focal plane of the image sensor 808. FIG. 8B illustrates a cross-sectional view 820 of the example configuration for the concentric light redirecting element 800 of FIG. 8A. In some cases, a concentric light redirecting element 800 as shown in FIG. 8A and FIG. 8B may provide a highly compact configuration for projecting a viewing position (e.g., first viewing position 602A, second viewing position 602B of FIG. 6A) onto the position of the image sensor 808.

FIG. 8C illustrates a perspective view of an additional example configuration for a concentric light redirecting element 840. As illustrated in FIG. 8C, the concentric light redirecting element 840 may include a light redirecting element 846 and an image sensor 848 In some cases, light incident on an external surface 842 of the concentric light redirecting element 840 can be redirected by light redirecting element 846 (e.g., a mirror) toward the second image sensor 848. In some cases, an optical system including the light redirecting element 846 may include one or more optical elements (not shown) configured to focus light at a focal plane of the image sensor 848. FIG. 8D illustrates a cross-sectional view 860 of the example configuration for the concentric light redirecting element 840 of FIG. 8C. In some cases, a concentric light redirecting element 840 as shown in FIG. 8C and FIG. 8D may provide a highly compact configuration for projecting a viewing position (e.g., first viewing position 602A, second viewing position 602B of FIG. 6A) onto the position of the image sensor 848. In some cases, the first light redirecting element 806 and the second light redirecting element 804 in the concentric light redirecting element 800 can be configured in a Newtonian configuration or a catadioptric configuration.

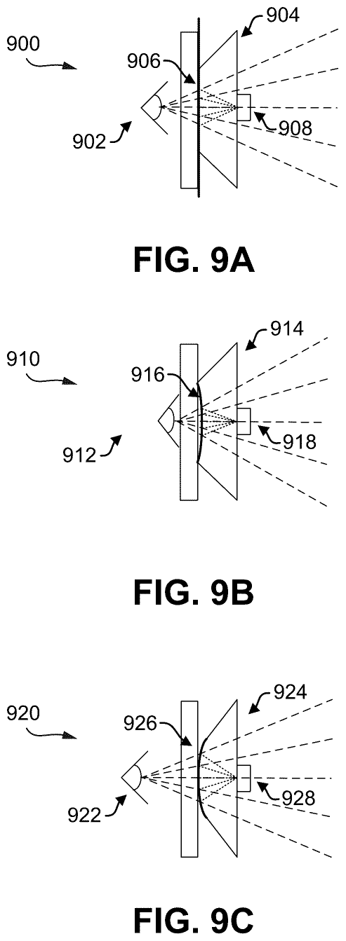

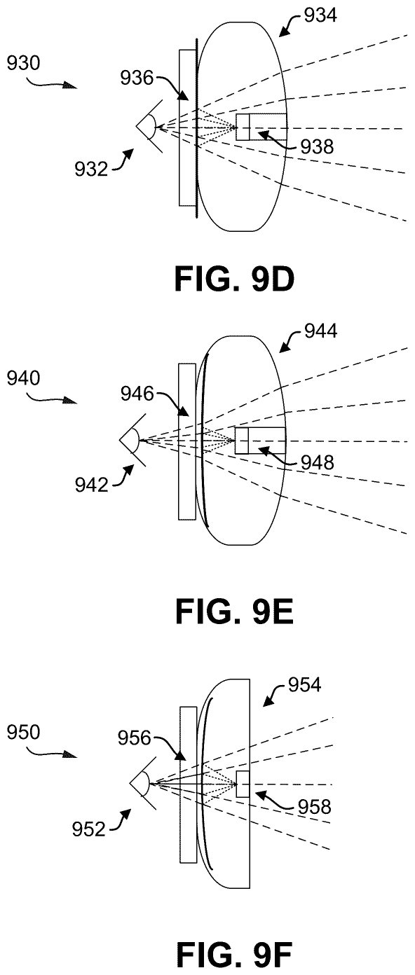

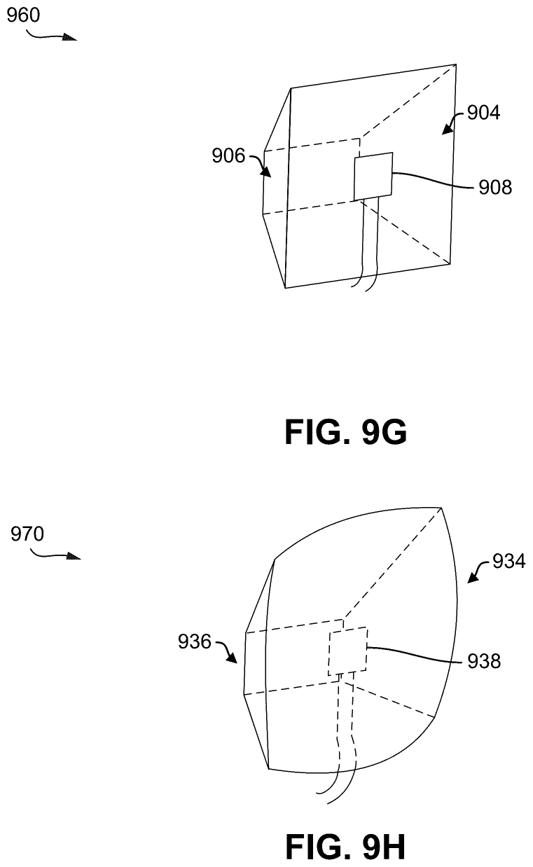

FIG. 9A through FIG. 9F provide example configurations for concentric light redirecting elements that include a single light redirecting surface similar to the concentric light redirecting element 840 of FIG. 8C and FIG. 8D. FIG. 9A through FIG. 9F are provided for the purposes of illustration to show a variety of different configurations that can be used in accordance with the systems and techniques described herein. It should be understood that similar principles can be applied to concentric light redirecting elements that include two or more light redirecting surfaces without departing from the scope of the present disclosure.

FIG. 9A illustrates an example cross-sectional view of a concentric light redirecting element 900 with a flat external surface 904 and a flat reflective surface 906. As shown in FIG. 9A, the concentric light redirecting element 900 can project the viewing position 902 (e.g., first viewing position 602A, second viewing position 602B of FIG. 6A) onto a position of an image sensor 908. In some examples, an optical system (not shown) may be configured to focus light at a focal plane of the image sensor 908. FIG. 9G illustrates an example perspective view 960 of the concentric light redirecting element 900 of FIG. 9A.

FIG. 9B illustrates an example cross-sectional view of a concentric light redirecting element 910 with a flat external surface 914 and a convex reflective surface 916. As shown in FIG. 9B, the concentric light redirecting element 910 can project the viewing position 912 (e.g., first viewing position 602A, second viewing position 602B of FIG. 6A) onto a position of an image sensor 918. In some examples, an optical system that includes the convex reflective surface 916 and/or one or more additional optical elements (not shown), may be configured to focus light at a focal plane of the image sensor 918.

FIG. 9C illustrates an example cross-sectional view of a concentric light redirecting element 920 with a flat external surface 924 and a concave reflective surface 926. As shown in FIG. 9C, the concentric light redirecting element 920 can project the viewing position 922 (e.g., first viewing position 602A, second viewing position 602B of FIG. 6A) onto a position of an image sensor 928. In some examples, an optical system that includes the concave reflective surface 926 and/or one or more additional optical elements (not shown), may be configured to focus light at a focal plane of the image sensor 928.

FIG. 9D illustrates an example cross-sectional view of a concentric light redirecting element 930 with a convex external surface 934 and a flat reflective surface 936. As shown in FIG. 9D, the concentric light redirecting element 930 can project the viewing position 932 (e.g., first viewing position 602A, second viewing position 602B of FIG. 6A) onto a position of an image sensor 938. In some examples, an optical system that includes the concave external surface 934 and/or one or more additional optical elements (not shown), may be configured to focus light at a focal plane of the image sensor 938. FIG. 9H illustrates an example perspective view 970 of the concentric light redirecting element 930 of FIG. 9D.

FIG. 9E illustrates an example cross-sectional view of a concentric light redirecting element 940 with a convex external surface 944 and a concave reflective surface 946. As shown in FIG. 9E, the concentric light redirecting element 940 can project the viewing position 942 (e.g., first viewing position 602A, second viewing position 602B of FIG. 6A) onto a position of an image sensor 948. In some examples, an optical system that includes the convex external surface 944, the concave reflective surface 946 and/or one or more additional optical elements (not shown), may be configured to focus light at a focal plane of the image sensor 948.

FIG. 9F illustrates an additional example cross-sectional view of a concentric light redirecting element 950 with a flat external surface 954 and a concave reflective surface 956. As shown in FIG. 9F, the concentric light redirecting element 950 can project the viewing position 952 (e.g., first viewing position 602A, second viewing position 602B of FIG. 6A) onto a position of an image sensor 958. In some examples, an optical system that includes the flat external surface 954 and/or one or more additional optical elements (not shown), may be configured to focus light at a focal plane of the image sensor 958.

In some examples, the example light redirecting configurations illustrated in FIG. 7A through FIG. 7E, FIG. 8A through FIG. 8D, and/or FIG. 9A through FIG. 9H may be fabricated as a single unit that includes one or more reflective surfaces. In some cases, the light redirecting configurations illustrated in FIG. 7A through FIG. 7E, FIG. 8A through FIG. 8D, and/or FIG. 9A through FIG. 9H may be configured to integrate an optical system (e.g., optical system 750 of FIG. 7C and FIG. 7D) and one or more light redirecting elements into a module. In some implementations, the example light redirecting configurations illustrated in FIG. 7A through FIG. 7E, FIG. 8A through FIG. 8D, and/or FIG. 9A through FIG. 9H may include two or more distinct elements.

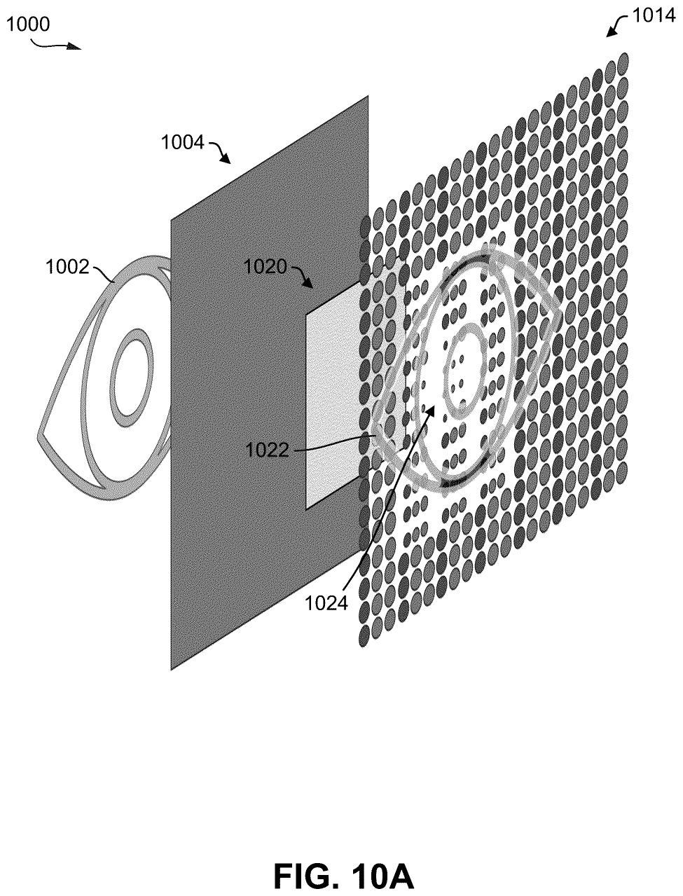

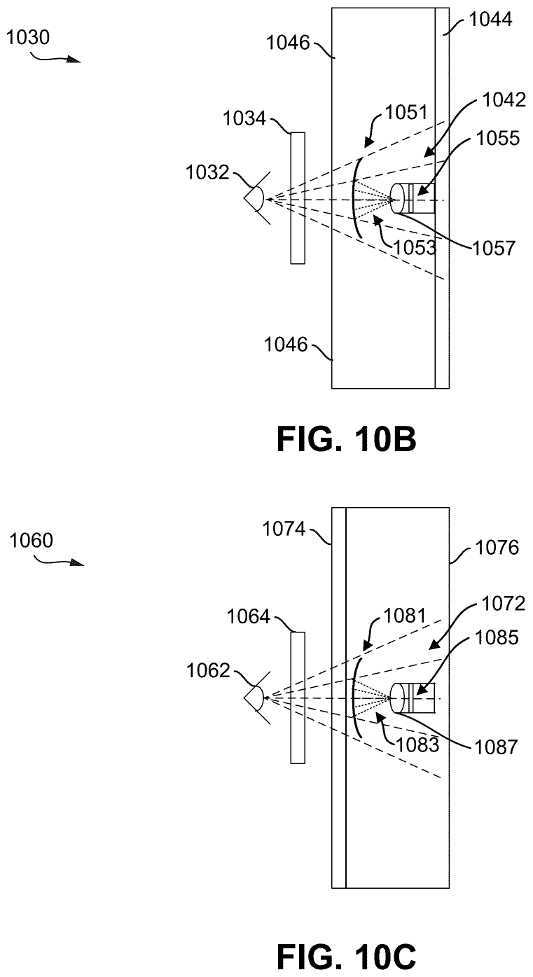

FIG. 10A illustrates an example configuration 1000 for an external facing display in a video pass-through system. In the example of FIG. 10A, a viewing position 1002 (e.g., a user's eye position), may be aligned with a display 1004. The display 1004 can correspond to, for example, display 209 of FIG. 2, display 505 of FIG. 5A, display 604A of FIG. 6A, display 604B of FIG. 6A, or any other display. In some cases, an image sensor 1020 can be coupled to a non-viewing side of the display 1004. In some examples, the image sensor 1020 can correspond to image sensor 620A of FIG. 6A, image sensor 620B of FIG. 6A, image sensor 710 of FIG. 7A, image sensor 730 of FIG. 7B, image sensor 752 of FIG. 7C and FIG. 7D, image sensor 792 of FIG. 7E, image sensor 808 of FIG. 8A and FIG. 8B, image sensor 848 of FIG. 8C and FIG. 8D, image sensor 908 of FIG. 9A and FIG. 9G, image sensor 918 of FIG. 9B, image sensor 928 of FIG. 9C, image sensor 938 of FIG. 9D and FIG. 9H, image sensor 948 of FIG. 9E, image sensor 958 of FIG. 9F, and/or any combination thereof. In some cases, the image sensor 1020 can be coupled to a non-viewing side of an external facing display 1014. In the illustrated example of FIG. 10A, the external facing display 1014 is configured to display an image in the opposite direction of the viewing position 1002 (e.g., toward an external facing surface of an HMD). In the illustrative example of FIG. 10A, the external facing display 1014 is shown displaying an image 1022 of an eye. In some cases, the image 1022 (e.g., an image of an eye) can be visible to a person viewing the video pass-through system (e.g., an HMD) from the outside. In some aspects, the external display 1014 may include transparent regions 1024 (e.g., empty pixels, reduced size pixels, etc.) that allow light to pass through and reach the image sensor 1020. In some cases, including transparent regions 1024 in the external display 1014 may allow for video pass-through operation when the external display would otherwise obscure the image sensor 1020 from capturing light from a scene (e.g., scene 525 of FIG. 5A, scene 550 of FIG. 5B).

FIG. 10B illustrates an example configuration 1030 for integrating a camera sensor with an external facing display using a light redirecting configuration. In the example of FIG. 10B, a light redirecting system 1046 can include a light redirecting element 1051, an optical system 1057, and an image sensor 1055. As illustrated in FIG. 10B, light rays 1042 from a scene (e.g., scene 525 of FIG. 5A, scene 550 of FIG. 5B) can be redirected by the light redirecting element 1051 and the resulting redirected light rays 1053 can be directed toward the optical system 1057 and the image sensor 1055. As shown in FIG. 10B, in some cases, the light redirecting system 1046 can be disposed between a display 1034 (e.g., display 1004 of FIG. 10A) and an external display 1044 (e.g., external display 1014 of FIG. 10A). In some examples, the light redirecting system 1046 can project the viewing position 1032 onto the image sensor 1055 as described with respect to the systems and techniques described herein.

FIG. 10C illustrates an additional example configuration 1060 for integrating a camera sensor with an external facing display using a light redirecting configuration. In the example of FIG. 10C, a light redirecting system 1076 can include a light redirecting element 1081, an optical system 1087, and an image sensor 1085. As illustrated in FIG. 10C, light rays 1072 from a scene (e.g., scene 525 of FIG. 5A, scene 550 of FIG. 5B) can be redirected by the light redirecting element 1081 and the resulting redirected light rays 1083 can be directed toward the optical system 1087 and the image sensor 1085. As shown, the light rays 1072 may be obscured by the external display 1074 and/or the display 1064 and prevented from reaching the viewing position 1062. As shown in FIG. 10C, in some cases, the light redirecting system 1076 can be disposed between an external display 1074 (e.g., external display 1014 of FIG. 10A) and the scene captured by the image sensor 1085. In some examples, the light redirecting system 1076 can project the viewing position 1062 onto the image sensor 1085 as described with respect to the systems and techniques described herein.

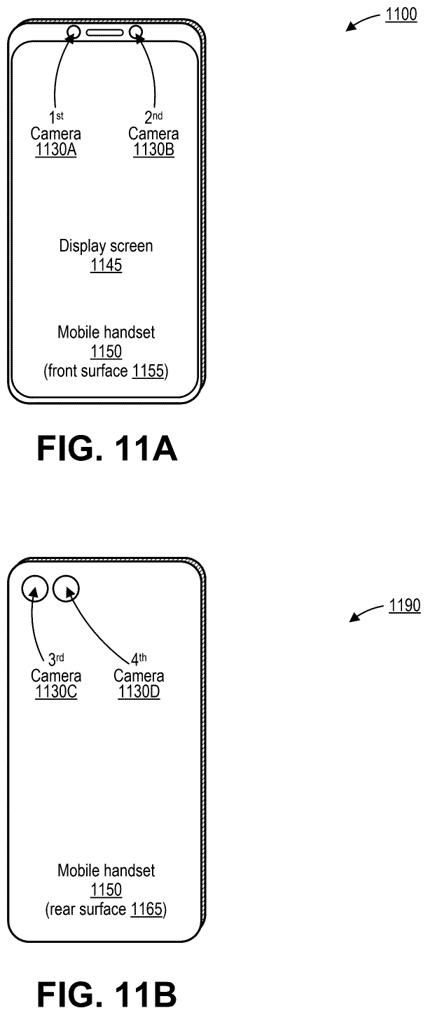

FIG. 11A is a perspective diagram 1100 illustrating a front surface 1155 of a mobile device 1150 that performs feature tracking and/or visual simultaneous localization and mapping (VSLAM) using one or more front-facing cameras 1130A-1130B, in accordance with some examples. The mobile device 1150 may be an example of a XR system 200, a SLAM system 300, a HMD 410, a HMD 510, or a combination thereof. The mobile device 1150 may be, for example, a cellular telephone, a satellite phone, a portable gaming console, a music player, a health tracking device, a wearable device, a wireless communication device, a laptop, a mobile device, any other type of computing device or computing system 1300 discussed herein, or a combination thereof. The front surface 1155 of the mobile device 1150 includes a display screen 1145. The front surface 1155 of the mobile device 1150 includes a first camera 1130A and a second camera 1130B. The first camera 1130A and the second camera 1130B are illustrated in a bezel around the display screen 1145 on the front surface 1155 of the mobile device 1150. In some examples, the first camera 1130A and the second camera 1130B can be positioned in a notch or cutout that is cut out from the display screen 1145 on the front surface 1155 of the mobile device 1150. In some examples, the first camera 1130A and the second camera 1130B can be under-display cameras that are positioned between the display screen 1145 and the rest of the mobile device 1150, so that light passes through a portion of the display screen 1145 before reaching the first camera 1130A and the second camera 1130B. The first camera 1130A and the second camera 1130B of the perspective diagram 1100 are front-facing cameras. The first camera 1130A and the second camera 1130B face a direction perpendicular to a planar surface of the front surface 1155 of the mobile device 1150. The first camera 1130A and the second camera 1130B may be two of the one or more cameras 310. In some examples, the front surface 1155 of the mobile device 1150 may only have a single camera. In some examples, the mobile device 1150 may include one or more additional cameras in addition to the first camera 1130A and the second camera 1130B. In some examples, the mobile device 1150 may include one or more additional sensors in addition to the first camera 1130A and the second camera 1130B.

FIG. 11B is a perspective diagram 1190 illustrating a rear surface 1165 of a mobile device 1150 that performs feature tracking and/or visual simultaneous localization and mapping (VSLAM) using one or more rear-facing cameras 1130C-1130D, in accordance with some examples. The mobile device 1150 includes a third camera 1130C and a fourth camera 1130D on the rear surface 1165 of the mobile device 1150. The third camera 1130C and the fourth camera 1130D of the perspective diagram 1190 are rear-facing. The third camera 1130C and the fourth camera 1130D face a direction perpendicular to a planar surface of the rear surface 1165 of the mobile device 1150. While the rear surface 1165 of the mobile device 1150 does not have a display screen 1145 as illustrated in the perspective diagram 1190, in some examples, the rear surface 1165 of the mobile device 1150 may have a second display screen. If the rear surface 1165 of the mobile device 1150 has a display screen 1145, any positioning of the third camera 1130C and the fourth camera 1130D relative to the display screen 1145 may be used as discussed with respect to the first camera 1130A and the second camera 1130B at the front surface 1155 of the mobile device 1150. The third camera 1130C and the fourth camera 1130D may be two of the one or more cameras 310. In some examples, the rear surface 1165 of the mobile device 1150 may only have a single camera. In some examples, the mobile device 1150 may include one or more additional cameras in addition to the first camera 1130A, the second camera 1130B, the third camera 1130C, and the fourth camera 1130D. In some examples, the mobile device 1150 may include one or more additional sensors in addition to the first camera 1130A, the second camera 1130B, the third camera 1130C, and the fourth camera 1130D.

Like the HMD 410, the mobile device 1150 includes no wheels, propellers, or other conveyance of its own. Instead, the mobile device 1150 relies on the movements of a user holding or wearing the mobile device 1150 to move the mobile device 1150 about the environment. Thus, in some cases, the mobile device 1150, when performing a SLAM technique, can skip path planning using the path planning engine and/or movement actuation using the movement actuator. In some cases, the mobile device 1150 can still perform path planning using the path planning engine, and can indicate directions to follow a suggested path to the user to direct the user along the suggested path planned using the path planning engine. In some cases, for instance where the mobile device 1150 is used for AR, VR, MR, or XR, the environment may be entirely or partially virtual. In some cases, the mobile device 1150 may be slotted into a HMD (e.g., into a cradle of the HMD) so that the mobile device 1150 functions as a display of the HMD, with the display screen 1145 of the mobile device 1150 functioning as the display of the HMD. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile device 1150. The movement actuator may include any such input device. Movement through the virtual environment may not require wheels, propellers, legs, or any other form of conveyance. If the environment is a virtual environment, then the mobile device 1150 can still perform path planning using the path planning engine and/or movement actuation. If the environment is a virtual environment, the mobile device 1150 can perform movement actuation using the movement actuator by performing a virtual movement within the virtual environment.

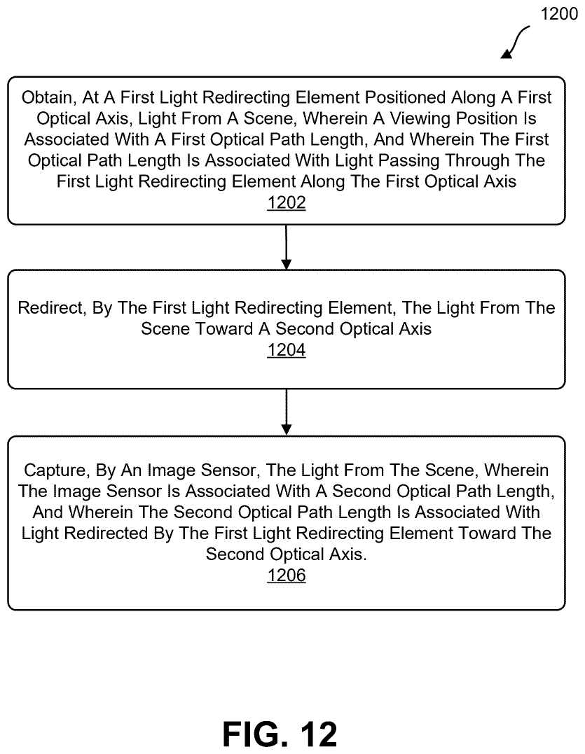

FIG. 12 is a flow diagram of a process 1200 for assembling an optical system including a meta-lens. The process 1200 may be performed by a computing device (or apparatus) or a component (e.g., a chipset, codec, etc.) of the computing device. The computing device may be a mobile device, a network-connected wearable such as a watch, an XR device such as a VR device or AR device, a vehicle or component or system of a vehicle, a network node/entity/device, wireless device, or other type of computing device. The operations of the process 1200 may be implemented as software components that are executed and run on one or more processors.

At block 1202, the computing device (or component thereof) may obtain, at a first light redirecting element (e.g., light redirecting elements 605A, 605B of FIG. 6A, light redirecting element 700 of FIG. 7A, light redirecting element 720 of FIG. 7B, light redirecting element 740 of FIG. 7C, concentric light redirecting element 800 of FIG. 8A and FIG. 8B, concentric light redirecting element 840 of FIG. 8C and FIG. 8D) positioned along a first optical axis (e.g., optical axis 608A, optical axis 608B of FIG. 6A, light from a scene. In some aspects, a viewing position (e.g., first viewing position 602A, second viewing position 602B of FIG. 6A) is associated with a first optical path length. In some cases, the first optical path length is associated with light passing through the first light redirecting element along the first optical axis.

At block 1204, the computing device (or component thereof) may redirect, by the first light redirecting element, the light from the scene toward a second optical axis.

At block 1206, the computing device (or component thereof) may capture, by an image sensor (e.g., image sensors 620A, 620B of FIG. 6A), the light from the scene. In some examples, the image sensor is associated with a second optical path length. In some implementations, the second optical path length is associated with light redirected by the first light redirecting element toward the second optical axis (e.g., redirected optical axis 618A, redirected optical axis 618B of FIG. 6A.

In some aspects, a display (e.g., displays 604A, 604B of FIG. 6A) is positioned between the viewing position and the image sensor. In examples, the display is opaque in a visible light spectrum. In some implementations, the display is at least partially transmissive in a visible light spectrum.

In some cases, a second light redirecting element (e.g., second light redirecting surface 748 of FIG. 7C) is positioned along the second optical axis (e.g., first redirected optical axis 746 of FIG. 7C). In some examples, the second light redirecting element is configured to redirect light from the first light redirecting element toward a third optical axis (e.g., second redirected optical axis 747 of FIG. 7C). In some implementations, the second optical axis is the first optical axis intersect to form an angle therebetween and the third optical axis is parallel with the first optical axis. In some aspects, the angle formed between the second optical axis and the first optical axis can be a right angle (e.g., 90 degrees). In some examples, the angle formed between the second optical axis and the first optical axis can be less than or greater than 90 degrees. In some cases, the image sensor is positioned along the third optical axis. In some aspects, the second light redirecting element is configured to redirect light from the second optical axis toward the image sensor. In some cases, the display is coupled to a first side of a PCB facing the viewing position and the image sensor is coupled to a second side of the PCB opposite the first side of the PCB. In some examples, at least one of the first light redirecting element or the second light redirecting element is configured to have a non-zero optical power (e.g., external surface 722 of FIG. 7B, light redirecting surface 724 of FIG. 7B, external surface 782 of FIG. 7E, first light redirecting surface 784 of FIG. 7E, second light redirecting surface 788 of FIG. 7E). In some aspects, a first optical path length between the first light redirecting element and the image sensor is configured to correspond to a second optical path length between the first light redirecting element and the viewing position.

In some cases, the computing device (or component thereof) may project a position of the image sensor onto the viewing position. In some aspects, the light redirecting system is configured to project a position of the image sensor onto the viewing position. In some examples, at least one surface of the first light redirecting element provides optical power.

In some implementations, a second light redirecting element is positioned along the second optical axis. In some cases, the second light redirecting element is configured to redirect light from the first light redirecting element toward a third optical axis. In some examples, the second optical axis is parallel to the first optical axis and the third optical axis is parallel to the first optical axis. In some cases, at least one surface of the second light redirecting element provides optical power (e.g., first light redirecting element 806 of FIG. 8A and FIG. 8B, second light redirecting element 804 of FIG. 8A and FIG. 8B, light redirecting element 846 of FIG. 8C and FIG. 8D, external surface 842 of FIG. 8C and FIG. 8D, convex external surface 934 of FIG. 9D, flat reflective surface 936 of FIG. 9D, convex external surface 944 of FIG. 9E, convex reflective surface 946 of FIG. 9E, convex reflective surface 956 of FIG. 9F, convex external surface 934 of FIG. 9H). In some aspects, the first light redirecting element and the second light redirecting element are configured in a Newtonian configuration or a catadioptric configuration.

In some examples, the viewing position corresponds to a position of an eye. In some implementations, the position of the eye is an assumed position of the eye. In some cases, the position of the eye is a measured position of the eye.

The process 1200 illustrated in FIG. 12 may also include any operation discussed illustrated in, or discussed with respect to, the image capture and processing system 100 of FIG. 1, the image capture device 105A of FIG. 1, the image processing device 105B of FIG. 1, the XR system 200 of FIG. 2, the SLAM system 300 of FIG. 3, the HMD 410 of FIG. 4A and/or FIG. 4B, or a combination thereof. The image capture technique of FIG. 12 may represent at least some of the operations of an image capture and processing system 100, an image capture device 105A, an image processing device 105B, an XR system 200, a SLAM system 300, a HMD 410, a mobile device 1150, a computing system 1300, or a combination thereof.

In some cases, at least a subset of the techniques illustrated by the process 1200 may be performed remotely by one or more network servers of a cloud service. In some examples, the processes described herein (e.g., process 1200 and/or other process(es) described herein) may be performed by a computing device or apparatus. In some examples, the process 1200 can be performed by the image capture device 105A of FIG. 1. In some examples, the process 1200 can be performed by the image processing device 105B of FIG. 1. The process 1200 can also be performed by the image capture and processing system 100 of FIG. 1. The process 1200 can also be performed by the XR device of FIG. 2, the SLAM system 300 of FIG. 3, the HMD 410 of FIG. 4A through FIG. 4B, the mobile device 1150 of FIG. 11A through FIG. 11B, a variation thereof, or a combination thereof.

The process 1200 can also be performed by a computing device with the architecture of the computing system 1300 shown in FIG. 13. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1200. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes illustrated by block diagrams in FIG. 1 (of image capture and processing system 100), FIG. 2 (of XR system 200), FIG. 3 (of SLAM system 300), FIG. 4A (of HMD 410), FIG. 4B (of HMD 410), FIG. 5A (of HMD 510), and FIG. 13 (of system 1300) and the flow diagram illustrating process 1200 are illustrative of, or organized as, logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes illustrated by block diagrams 100, 200, 300, and 1300 and the flow diagram illustrating process 1200 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300, which can be for example any computing device making up the image capture and processing system 100, the image capture device 105A, the image processing device 105B, the XR system, the SLAM system 300, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 1300 includes at least one processing unit (CPU or processor) 1310 and connection 1305 that couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, etc. Computing system 1300 can also include output device 1335, which can be one or more of a number of output mechanisms. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1002.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An optical system comprising: a display positioned along a first optical axis, wherein the first optical axis passes through a viewing plane of the display and intersects with a viewing position; a light redirecting system comprising a first light redirecting element positioned along the first optical axis, wherein the first light redirecting element is configured to redirect light from a scene toward a second optical axis; and an image sensor, wherein the light redirecting system is configured to redirect the light from the scene toward the image sensor.

Aspect 2: The optical system of Aspect 1, wherein the display is positioned between the viewing position and the image sensor.

Aspect 3: The optical system of any one of Aspects 1 or 2, wherein the optical system further comprises: a second light redirecting element positioned along the second optical axis, wherein the second light redirecting element is configured to redirect light from the first light redirecting element toward a third optical axis, wherein the second optical and the first optical axis intersect to form an angle therebetween and the third optical axis is parallel with the first optical axis.

Aspect 4: The optical system of Aspect 3, wherein the image sensor is positioned along the third optical axis.

Aspect 5: The optical system of Aspect 3, wherein the second light redirecting element is configured to redirect light from the second optical axis toward the image sensor.

Aspect 6: The optical system of Aspect 3, wherein the display is coupled to a first side of a printed circuit board (PCB) facing the viewing position and the image sensor is coupled to a second side of the PCB opposite the first side of the PCB.

Aspect 7: The optical system of Aspect 3, wherein at least one of the first light redirecting element or the second light redirecting element is configured to have a non-zero optical power.

Aspect 8: The optical system of any one of Aspects 1 to 7, wherein a first optical path length between the first light redirecting element and the image sensor is configured to correspond to a second optical path length between the first light redirecting element and the viewing position.

Aspect 9: The optical system of Aspect 8, wherein the first optical path length differs from the second optical path length by less than 2 centimeter (cm).

Aspect 10: The optical system of any one of Aspects 1 to 9, wherein the light redirecting system is configured to project a position of the image sensor onto the viewing position.

Aspect 11: The optical system of Aspect 10, wherein at least one surface of the first light redirecting element provides optical power.

Aspect 12: The optical system of any one of Aspects 1 to 11, wherein the optical system further comprises: a second light redirecting element positioned along the second optical axis, wherein the second light redirecting element is configured to redirect light from the first light redirecting element toward a third optical axis, wherein the second optical axis is parallel to the first optical axis and the third optical axis is parallel to the first optical axis.

Aspect 13: The optical system of Aspect 10, wherein at least one surface of the second light redirecting element provides optical power.

Aspect 14: The optical system of Aspect 12, wherein the first light redirecting element and the second light redirecting element are configured in a Newtonian configuration or a catadioptric configuration.

Aspect 15: The optical system of any one of Aspects 1 to 14, wherein the viewing position corresponds to a position of an eye.

Aspect 16: The optical system of Aspect 15, wherein the position of the eye is an assumed position of the eye.

Aspect 17: The optical system of Aspect 15, wherein the position of the eye is a measured position of the eye.

Aspect 18: The optical system of any one of Aspects 1 to 17, wherein the display is opaque in a visible light spectrum.

Aspect 19: The optical system of any one of Aspects 1 to 18, wherein the display is at least partially transmissive in a visible light spectrum.

Aspect 20: The optical system of any one of Aspects 1 to 19, further comprising an additional display, wherein the additional display is disposed between the scene and the first light redirecting element, and wherein light from the scene received at the image sensor passes through the additional display.

Aspect 21: The optical system of any one of Aspects 1 to 20, further comprising at least one of a motor, an actuator, or a piezoelectric component configured to adjust an optical path length between the first light redirecting element and the image sensor.

Aspect 22: The optical system of any one of Aspects 1 to 21, wherein the light redirecting system comprises one or more optical elements configured to focus the light from the scene on the image sensor.

Aspect 23: A method for redirecting light, the method comprising: obtaining, at a first light redirecting element positioned along a first optical axis, light from a scene, wherein a viewing position is associated with a first optical path length, and wherein the first optical path length is associated with light passing through the first light redirecting element along the first optical axis; redirecting, by the first light redirecting element, the light from the scene toward a second optical axis; and capturing, by an image sensor, the light from the scene, wherein the image sensor is associated with a second optical path length, and wherein the second optical path length is associated with light redirected by the first light redirecting element toward the second optical axis.

Aspect 24: A non-transitory computer-readable storage medium having stored thereon instructions which, when executed by one or more processors, cause the one or more processors to perform any of the operations of aspects 1 to 23.

Aspect 25: An apparatus comprising means for performing any of the operations of aspects 1 to 23.

What is claimed is:

1. An optical system comprising:
a display positioned along a first optical axis, wherein the first optical axis passes through a viewing plane of the display and intersects with a viewing position;
a first light redirecting element positioned along the first optical axis, wherein the first light redirecting element is configured to redirect light from a scene toward a second optical axis; and
an image sensor, wherein the image sensor is configured to receive the light from the scene and wherein the first light redirecting element is included along an optical path between the scene and the image sensor.

2. The optical system of claim 1, wherein the display is positioned between the viewing position and the image sensor.

3. The optical system of claim 1, further comprising:
a second light redirecting element positioned along the second optical axis, wherein the second light redirecting element is configured to redirect light from the first light redirecting element toward a third optical axis, wherein the second optical axis and the first optical axis intersect to form an angle therebetween, and the third optical axis is parallel with the first optical axis.

4. The optical system of claim 3, wherein the image sensor is positioned along the third optical axis.

5. The optical system of claim 3, wherein the second light redirecting element is configured to redirect light from the second optical axis toward the image sensor.

6. The optical system of claim 3, wherein the display is coupled to a first side of a printed circuit board (PCB) facing the viewing position and the image sensor is coupled to a second side of the PCB opposite the first side of the PCB.

7. The optical system of claim 3, wherein at least one of the first light redirecting element or the second light redirecting element is configured to have a non-zero optical power.

8. The optical system of claim 1, wherein a first optical path length between the first light redirecting element and the image sensor is configured to correspond to a second optical path length between the first light redirecting element and the viewing position.

9. The optical system of claim 1, wherein the light redirecting system is configured to project a position of the image sensor onto the viewing position.

10. The optical system of claim 9, wherein at least one surface of the first light redirecting element provides optical power.

11. The optical system of claim 1, wherein the optical system further comprises:
a second light redirecting element positioned along the second optical axis, wherein the second light redirecting element is configured to redirect light from the first light redirecting element toward a third optical axis, wherein the second optical axis is parallel to the first optical axis and the third optical axis is parallel to the first optical axis.

12. The optical system of claim 11, wherein at least one surface of the second light redirecting element provides optical power.

13. The optical system of claim 11, wherein the first light redirecting element and the second light redirecting element are configured in a Newtonian configuration or a catadioptric configuration.

14. The optical system of claim 1, wherein the viewing position corresponds to a position of an eye.

15. The optical system of claim 14, wherein the position of the eye is an assumed position of the eye.

16. The optical system of claim 14, wherein the position of the eye is a measured position of the eye.

17. The optical system of claim 1, wherein the display is opaque in a visible light spectrum.

18. The optical system of claim 1, wherein the display is at least partially transmissive in a visible light spectrum.

19. The optical system of claim 1 further comprising an additional display, wherein the additional display is disposed between the scene and the first light redirecting element, and wherein light from the scene received at the image sensor passes through the additional display.

20. The optical system of claim 1, wherein the light redirecting system comprises one or more optical elements configured to focus the light from the scene on the image sensor.

21. The optical system of claim 1, further comprising at least one of a motor, an actuator, or a piezoelectric component configured to adjust an optical path length between the first light redirecting element and the image sensor.

22. A method for redirecting light, the method comprising:
obtaining, at a first light redirecting element positioned along a first optical axis, light from a scene, wherein a viewing position is associated with a first optical path length, and wherein the first optical path length is associated with light passing through the first light redirecting element along the first optical axis;
redirecting, by the first light redirecting element, the light from the scene toward a second optical axis; and
capturing, by an image sensor, the light from the scene, wherein the image sensor is associated with a second optical path length, and wherein the second optical path length is associated with light redirected by the first light redirecting element toward the second optical axis.
